(19) United States
(12) Patent Application Publication
(10) Pub. No.: US 2024/0419530 A1
(43) Pub. Date: Dec. 19, 2024

(54) METHODS AND SYSTEMS FOR INCORPORATING USER FEEDBACK IN DISCOVERING AND CORRECTING INCIDENTS IN A DATA CENTER

(71) Applicant: VMware, Inc., Palo Alto, CA (US)

(72) Inventors: Ashot Nshan Harutyunyan, Yerevan (AM); Arnak Poghosyan, Yerevan (AM); Artur Grigoryan, Yerevan (AM); Vahan Tadevosyan, Yerevan (AM); Vahe Mikayelyan, Yerevan (AM)

(73) Assignee: VMware, Inc., Palo Alto, CA (US)

(21) Appl. No.: 18/336,799

(22) Filed: Jun. 16, 2023

(51) Int. Cl. G06F 11/07

(52) U.S. Cl. CPC G06F 11/0793; G06F 11/0769

(57) ABSTRACT

Automated computer-implemented methods and systems for discovering incidents occurring with objects running in a data center and executing remedial measures that correct the incidents are described herein. The methods and systems discover clusters of alerts in a stream of alerts triggered by a stream of events occurring with objects in the data center. User feedback is used to identify alerts with related event types in each cluster of alerts that corresponds to separate incidents occurring in the data center. The methods and system compare a set of runtime alerts to each incident to determine one or more similar incidents to the set of runtime alerts. The one or more similar incidents and corresponding remedial measures are displayed in a GUI with each remedial measure selectable to launch an operation that corrects one of the problems represented by the one or more similar incidents.

### TECHNICAL FIELD

This disclosure is directed to methods and systems for discovering and correcting incidents in a data center.

### BACKGROUND

Electronic computing has evolved from primitive, vacuum-tube-based computer systems, initially developed during the 1940s, to modern electronic computing systems in which large numbers of multi-processor computer systems, such as server computers and workstations, are networked together with large-capacity data-storage devices to produce geographically distributed computing systems that provide enormous computational bandwidths and data-storage capacities. These large, distributed computing systems include data centers and are made possible by advancements in virtualization, computer networking, distributed operating systems and applications, data-storage appliances, computer hardware, and software technologies. The number and size of data centers has grown in recent years to meet the increasing demand for information technology (“IT”) services, such as running applications for organizations that provide business services, web services, streaming services, and other cloud services to millions of users each day.

Advancements in virtualization and software technologies provide many advantages for development and deployment of applications in data centers. Enterprises, governments, and other organizations now conduct commerce, provide services over the internet, and process large volumes of data using distributed applications executed in data centers. A distributed application comprises multiple software components that are executed in virtual machines (“VMs”), or in containers, on multiple server computers of a data center. The software components communicate and coordinate data processing and data stores to appear as a single coherent application that provides services to end users. As result, data centers run tens of thousands of distributed applications in VMs and containers that can be scaled up or down to meet customer and client demands. For example, VMs that provide a service can be created to satisfy increasing demand for services and deleted when demand for the services decreases, which frees up computing resources. VMs and containers can also be migrated to different host server computers within a data center to optimize use of resources.

Organizations that rely on data centers to run their applications cannot afford performance problems that result in downtime or slow execution of their applications. Such issues frustrate application users, damage a brand name, result in lost revenue, and, in some cases, denying users access to vital services. Data center system administrators are tasked with monitoring thousands of dynamically changing data center objects, such as VMs, containers, server computers, and network devices, for events that create performance problems and take immediate corrective action when problems occur. Operation management tools have been developed to aid system administrators with monitoring data center objects for abnormal behavior. These tools detect events that indicate abnormal behavior of an object and start alerts on a system administrator's consoles to notify system administrators of the abnormal events. However, typical operations management tools do not include features that aid system administrators with understanding and prioritizing streams of events that originate from various sources and occur in short time periods. Such high-volume events are called an “event storm.” Most event storms originate from a multitude of objects and can produce hundreds and in some cases thousands of alerts in a short period of time, such as minutes to a few hours. Even with the aid of current operation management tools, understanding and prioritizing events of a stream of events to determine the source, or sources, of the problems and apply appropriate remedial actions are beyond the capabilities of system administrators. System administrators seek automated processes and systems that aid system administrators with discovering, diagnosing, and remedying problems that create streams of events in real time while objects are executing in a data center.

### SUMMARY

This disclosure is directed to automated computer-implemented methods and systems for discovering incidents occurring with objects running in a data center and executes remedial measures that correct the incidents. The methods and systems enable a user to execute a process that discovers clusters of alerts in a stream of alerts triggered by a stream of events occurring with objects in the data center via a graphical user interface (“GUI”) displayed on the display screen. The GUI is used to receive user feedback that identifies alerts with related event types in each cluster of alerts, each set of alerts with related event types corresponding to a separate incident occurring with objects in the data center. Each incident is stored in an incidents database. The methods and system compare a set of runtime alerts to each incident stored in the incidents database to determine one or more incidents that are similar to the set of runtime alerts. The one or more similar incidents and corresponding remedial measures are displayed in the GUI with each remedial measure selectable to launch an operation that corrects one of the problems represented by the one or more similar incidents. In response to the user selecting one of the remedial measures via the GUI, the remedial measures are executed to correct a problem with the one or more objects that triggered the set of runtime alerts.

### DESCRIPTION OF THE DRAWINGS

FIG. 1 shows an architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machines (“VMs”) and VM execution environments.

FIG. 6 shows an example of an open virtualization format package.

FIG. 7 shows examples of virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing containers on a VM.

FIG. 13 shows an example of a virtualization layer located above a physical data center.

FIGS. 14A-14B show examples of operations performed by an operations management server receiving metrics from physical and virtual objects of the data center.

FIG. 15 shows an example architecture of an operations management server.

FIG. 16 shows a plot of an example metric.

FIG. 17 shows an example data center graph that represents a topology objects in a data center.

FIG. 18 shows an example of objects of a data center graph with events that trigger alerts.

FIG. 19 shows an example of alert information recorded in a data table of an alerts database.

FIGS. 20A-20F show an example of time evolution of alerts triggered by related and unrelated events in a stream of events occurring in objects of a data center.

FIG. 21 shows an example of a neighborhood.

FIGS. 22A-22C show examples of a core alert, a border alert, and noise, respectively.

FIG. 22D shows an example of a density reachable alert.

FIG. 23 shows an example graphical user interface (“GUI”).

FIG. 24 shows an example of a runtime window partitioned into four equal duration time intervals.

FIG. 25 shows a data table that represents alerts with start times in a runtime window retrieved from an alerts database.

FIGS. 26-32 show a process of detecting clusters of the alerts.

FIGS. 33A-33I show an example of using time evolution to grow a cluster of alerts.

FIGS. 34A-34C show an example of using coverage evolution to identify a cluster of alerts.

FIGS. 35A-37B show example of GUIs used to designate alerts as “not indicative,” “indicative,” and “root cause.”

FIG. 38 shows an example of using a not indicative event types database created by a user to designate runtime not indicative alerts.

FIG. 39 shows an example of using a not indicative event types database created by multiple users to designate runtime not indicative alerts.

FIG. 40 shows an example plot of clusters of alerts composed of incidents.

FIGS. 41A-41C show an example GUI that enables a user to view each discovered incident and input feedback and troubleshoot a root cause of incidents in an incidents database.

FIG. 42 shows an example portion of K incident data files of an incidents database.

FIG. 43 shows examples of computing similarity scores for two incidents recorded in an incidents database.

FIG. 44 shows a GUI that displays information about a runtime incident and similar previous incidents.

FIG. 45 is a flow diagram of a method for discovering and correcting incidents occurring with objects running in a data center.

FIG. 46 is a flow diagram of the “discover clusters of alerts in a stream of alerts triggered by a stream of events occurring with objects in the data center” procedure performed in FIG. 45.

FIG. 47 is a flow diagram of the “discover clusters of alerts in a stream of alerts triggered by a stream of events occurring with objects in the data center” procedure performed in FIG. 45.

FIG. 48 is a flow diagram the “discover clusters of alerts in a stream of alerts triggered by a stream of events occurring with objects in the data center” procedure performed in FIG. 45.

FIG. 49 is a flow diagram of the “identify incidents in each cluster of alerts and store each incident in an incidents database” procedure performed in FIG. 45.

FIG. 50 is a flow diagram of the “identify incidents in each cluster of alerts and store each incident in an incidents database” procedure performed in FIG. 45.

FIG. 51 is a flow diagram of the “compare a set of runtime alerts to each incident stored in the incidents database to determine one or more incidents that are similar to the set of runtime alert” procedure performed in FIG. 45.

### DETAILED DESCRIPTION

This disclosure presents automated computer-implemented methods and systems for discovering and resolving incidents discovered in streams of events occurring in a data center. In a first subsection, computer hardware, complex computational systems, and virtualization are described. Computer-implemented methods and systems for discovering and resolving incidents in a data center are described below in a second subsection.

### Computer Hardware, Complex Computational Systems, and Virtualization

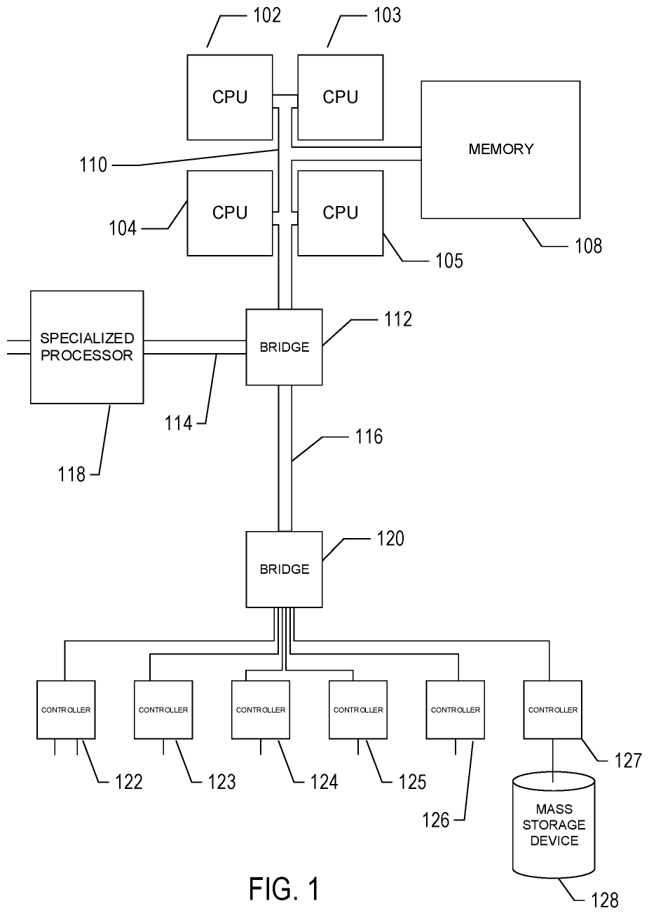

FIG. 1 shows a general architectural diagram for various types of computers. Computers that receive, process, and store log messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

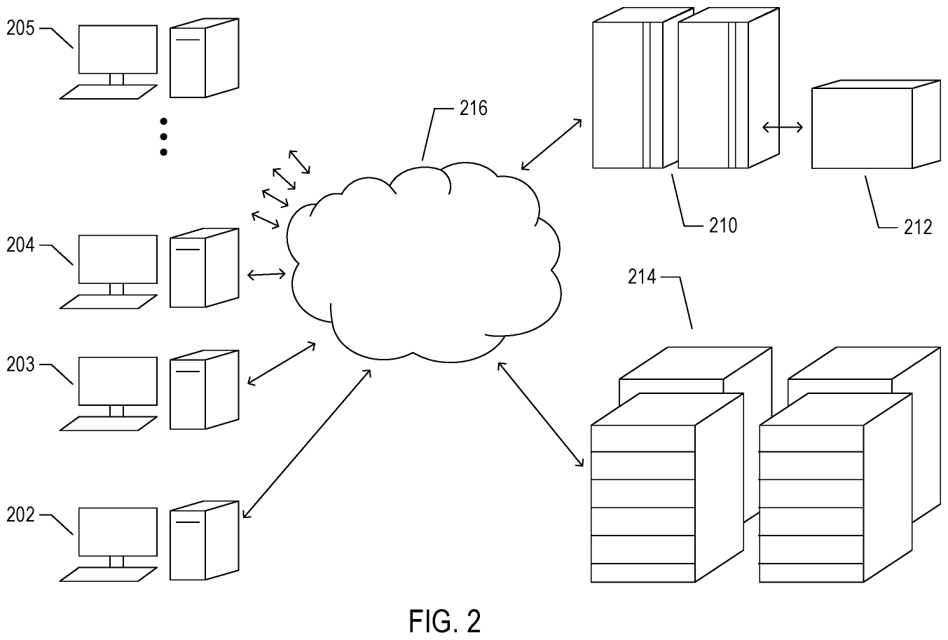

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web server computers, back-end computer systems, and data-storage systems for serving web pages to remote customers, receiving orders through the web-page interface, processing the orders, tracking completed orders, and other myriad different tasks associated with an e-commerce enterprise.

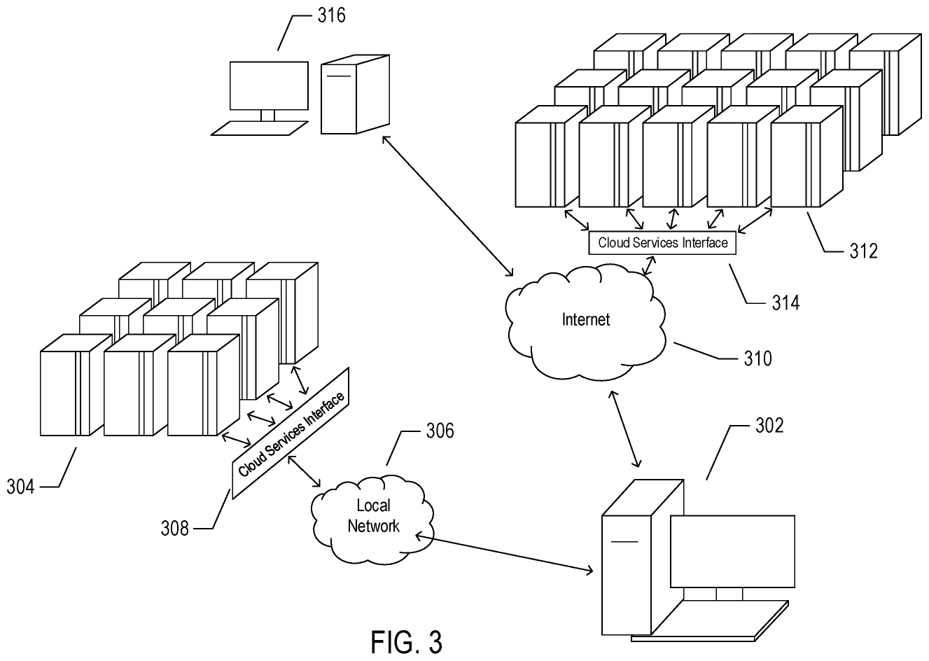

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

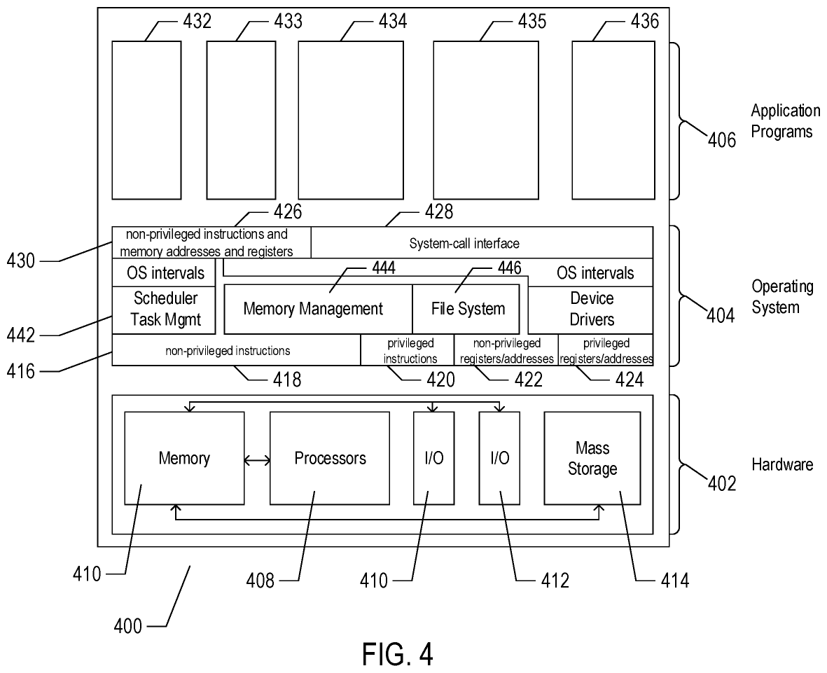

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

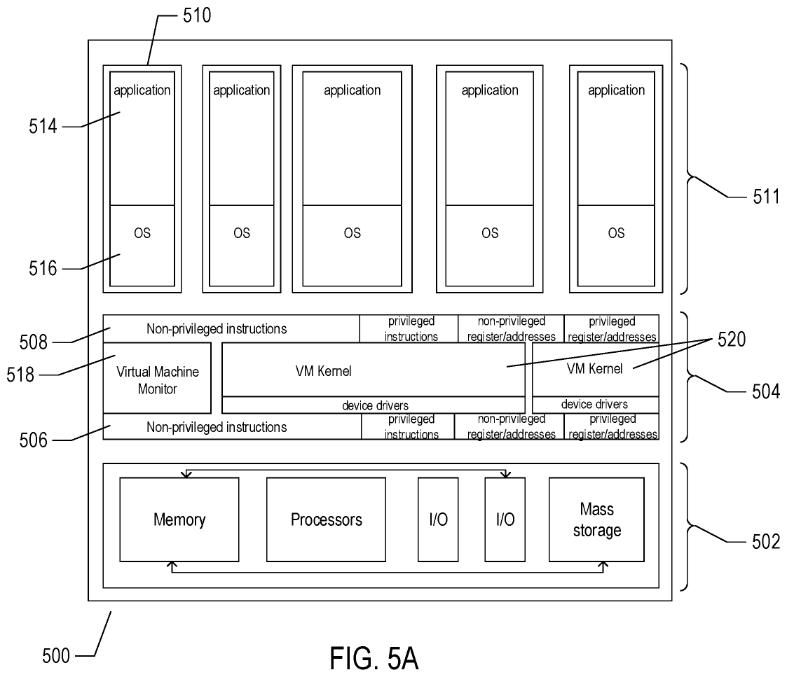

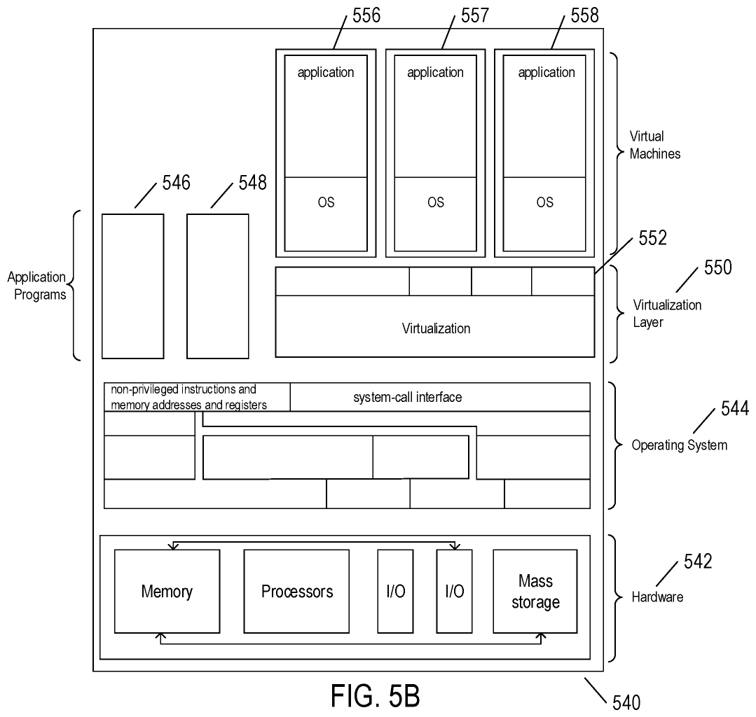

For all of these reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtualization layer 504 that interfaces through a virtualization-layer/hardware-layer interface 506, equivalent to interface 416 in FIG. 4, to the hardware. The virtualization layer 504 provides a hardware-like interface to VMs, such as VM 510, in a virtual-machine layer 511 executing above the virtualization layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization layer interface 504 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization layer 504 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization layer 504, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The hardware-layer interface 552, equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

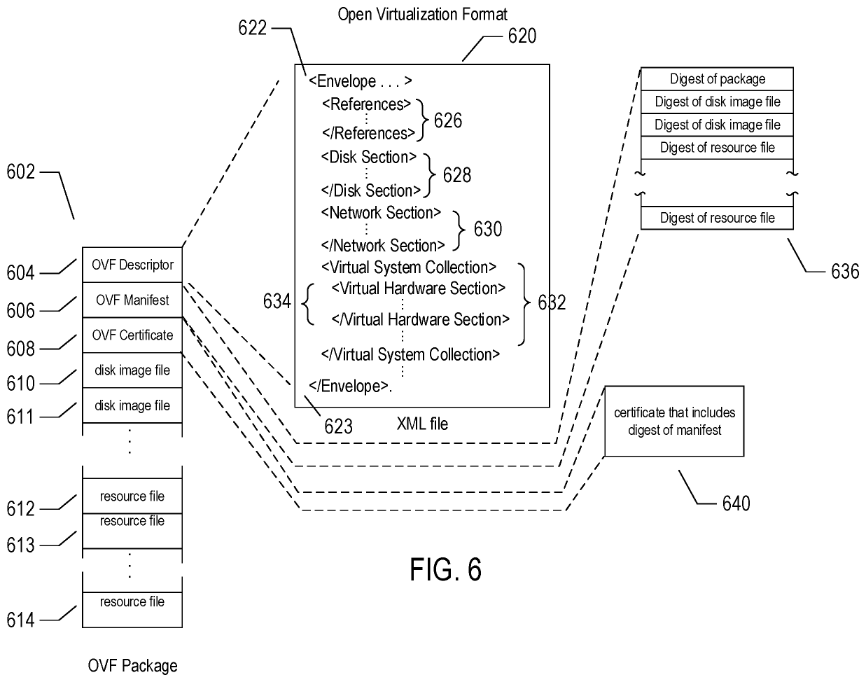

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a network section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing. XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

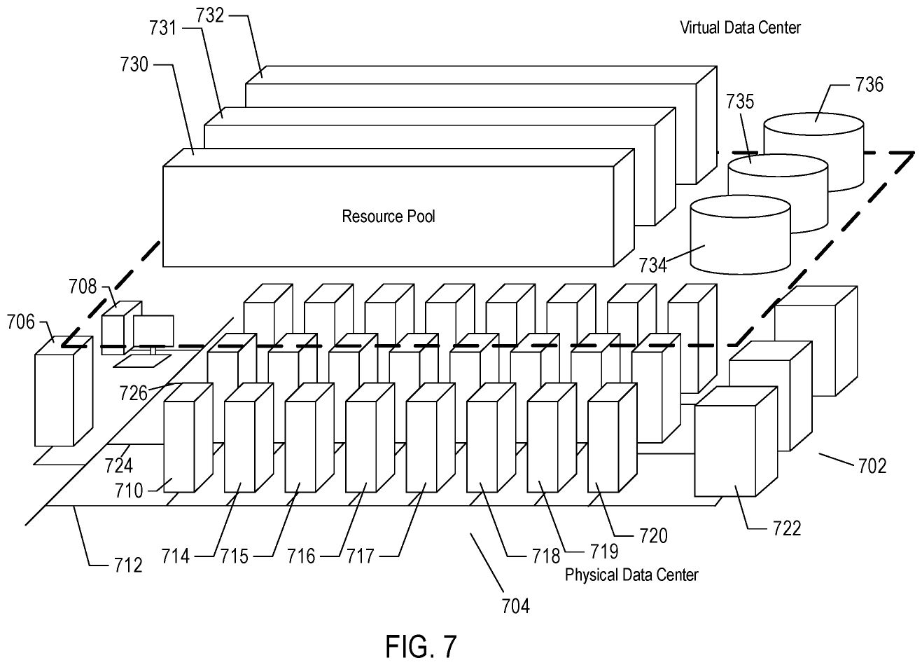

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of various different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight server computers and a mass-storage array. The individual server computers, such as server computer 710, each includes a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of server computers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server computer 706 includes functionality to migrate running VMs from one server computer to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual server computers and migrating VMs among server computers to achieve load balancing, fault tolerance, and high availability.

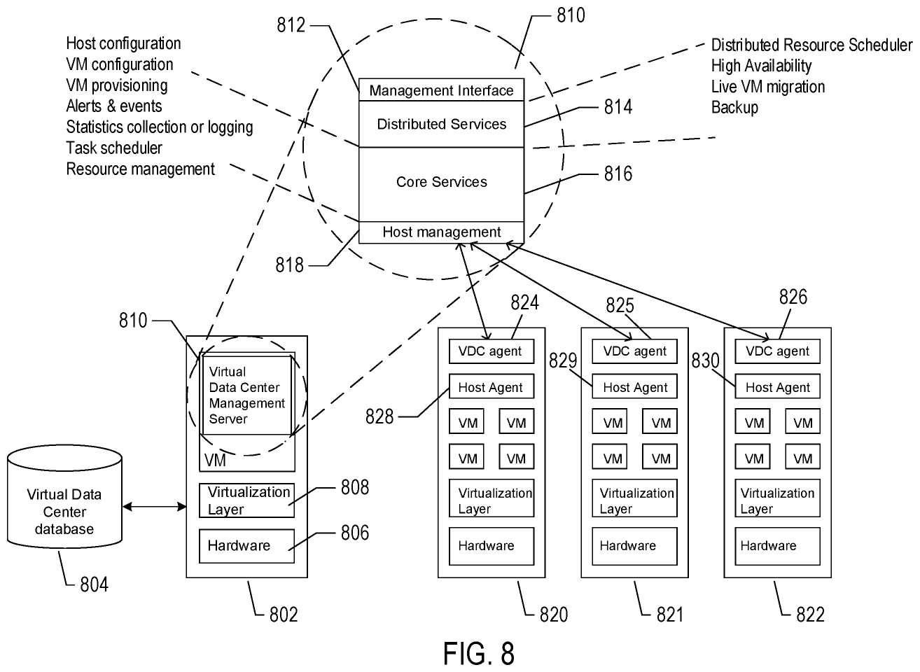

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtualization layer 808 and runs a virtual-data-center management-server VM 810 above the virtualization layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer, and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtualization layer can be accessed via a virtual-infrastructure application programming interface (“API”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents, monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant associated VDCs that can each be allocated to an individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

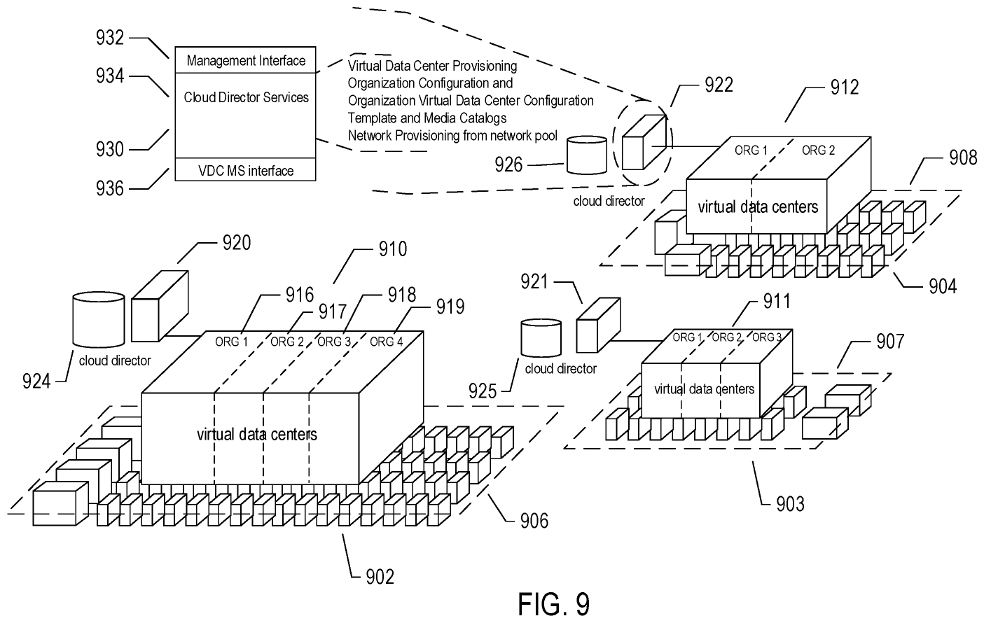

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director server computers 920-922 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

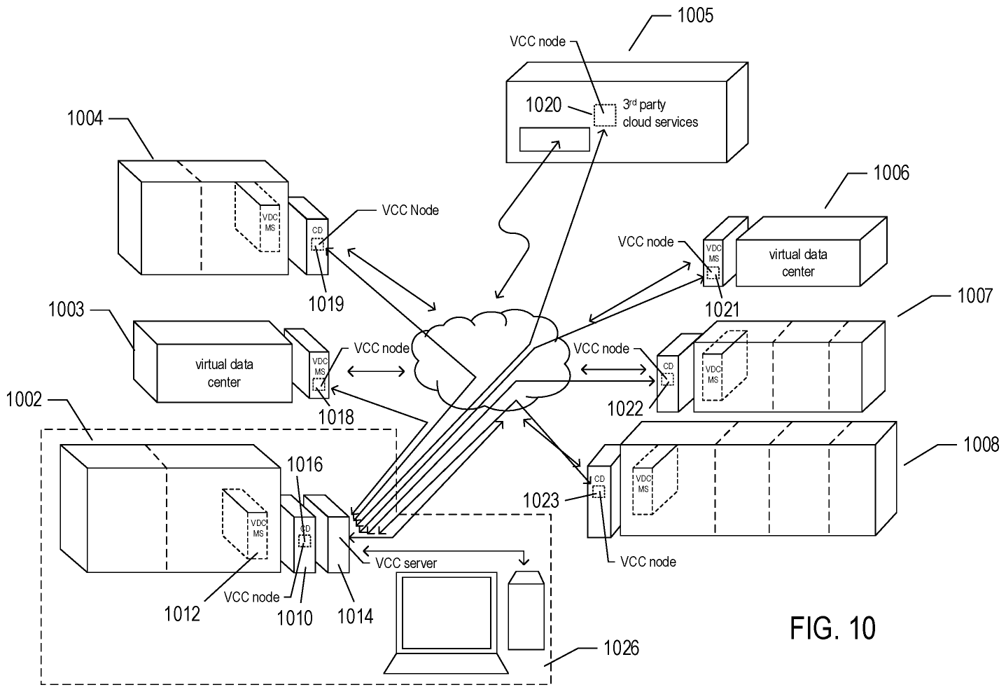

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

As mentioned above, while the virtual-machine-based virtualization layers, described in the previous subsection, have received widespread adoption and use in a variety of different environments, from personal computers to enormous, distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

While a traditional virtualization layer can simulate the hardware interface expected by any of many different operating systems, OSL virtualization essentially provides a secure partition of the execution environment provided by a particular operating system. A container is an abstraction at the application layer that packages code and dependencies together. Multiple containers can run on the same computer system and share the operating system kernel, each container running as an isolated process in the user space. One or more containers are run in pods. For example, OSL virtualization provides a file system to each container, but the file system provided to the container is essentially a view of a partition of the general file system provided by the underlying operating system of the host. In essence, OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. The containers are isolated from one another and bundle their own software, libraries, and configuration files within in the pods. A container cannot access files that are not included in the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtualization layers. Again, however, OSL virtualization does not provide many desirable features of traditional virtualization. As mentioned above, OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies.

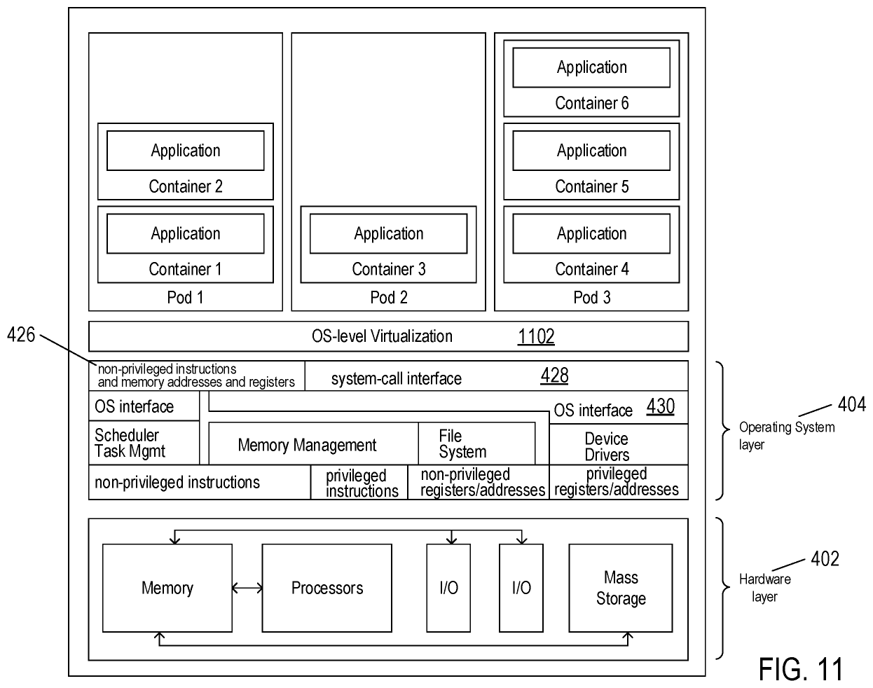

FIG. 11 shows an example server computer used to host three pods. As discussed above with reference to FIG. 4, an operating system layer 404 runs on the hardware layer 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly on the operating system layer 404, OSL virtualization involves an OSL virtualization layer 1102 that provides operating-system interfaces to each of the pods 1-3. In this example, applications are run separately in containers 1-6 that are in turn run in pods identified as Pod 1, Pod 2, and Pod 3. Each pod runs one or more containers with shared storage and network resources, according to a specification for how to run the containers. For example, Pod 1 runs an application 1104 in container 1 and another application 1106 in a container identified as container 2.

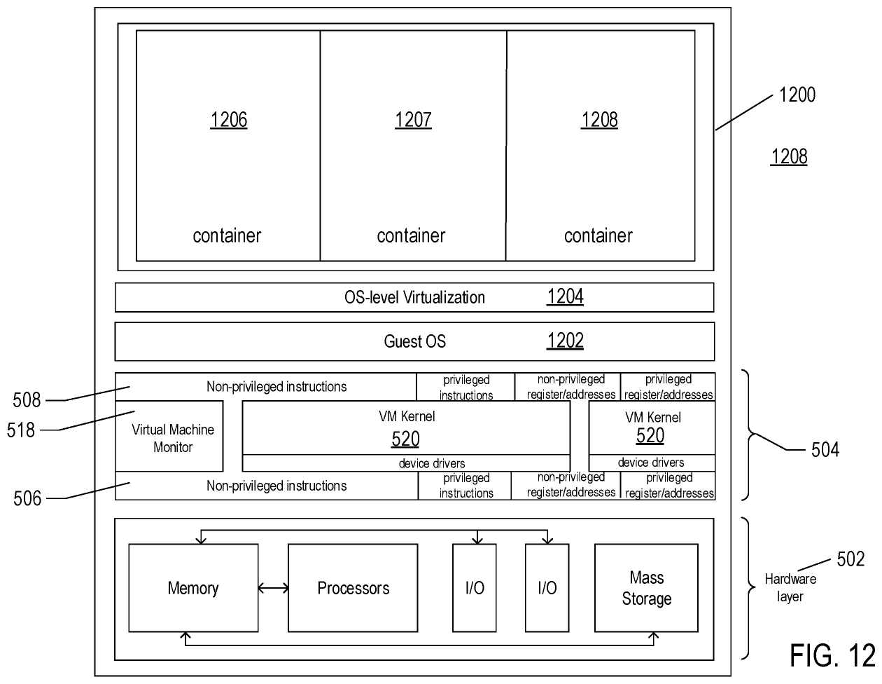

FIG. 12 shows an approach to implementing the containers in a VM. FIG. 12 shows a host computer similar to that shown in FIG. 5A, discussed above. The host computer includes a hardware layer 502 and a virtualization layer 504 that provides a virtual hardware interface 508 to a guest operating system 1202. Unlike in FIG. 5A, the guest operating system interfaces to an OSL-virtualization layer 1204 that provides container execution environments 1206-1208 to multiple application programs.

Note that, although only a single guest operating system and OSL virtualization layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtualization layers to provide containers for running applications is referred to, in the following discussion, as a “hybrid virtualized distributed computing system.”

Running containers above a guest operating system within a VM provides advantages of traditional virtualization in addition to the advantages of OSL virtualization. Containers can be quickly booted in order to provide additional execution environments and associated resources for additional application instances. The resources available to the guest operating system are efficiently partitioned among the containers provided by the OSL-virtualization layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling, and other such features. Containers provide share-based allocation of computational resources to groups of applications with guaranteed isolation of applications in one container from applications in the remaining containers executing above a guest operating system. Moreover, resource allocation can be modified at runtime between containers. The traditional virtualization layer provides for flexible and scaling over large numbers of hosts within large, distributed computing systems and a simple approach to operating-system upgrades and patches. Thus, the use of OSL virtualization above traditional virtualization in a hybrid virtualized distributed computing system, as shown in FIG. 12, provides many of the advantages of both a traditional virtualization layer and the advantages of OSL virtualization.

### Computer-Implemented Methods and Systems for Discovering and Correcting Incidents in a Data Center

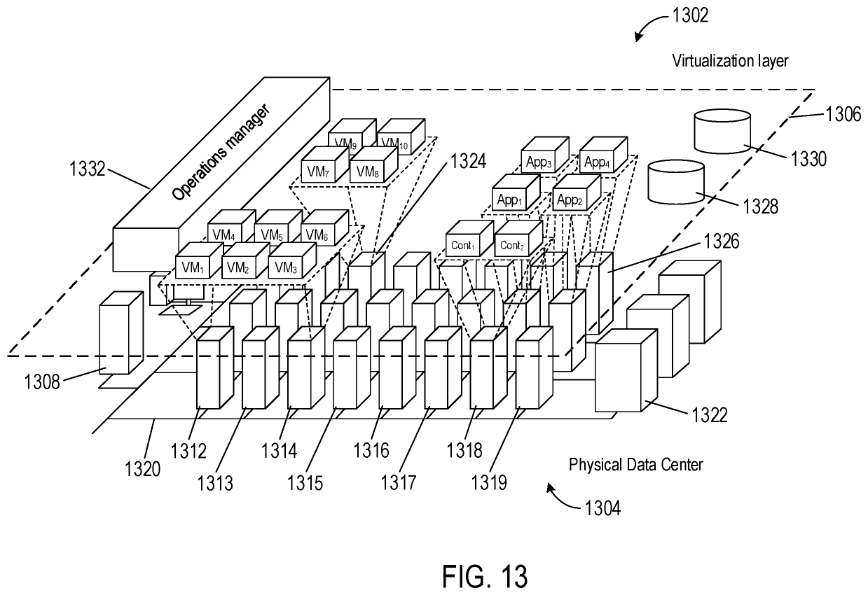

FIG. 13 shows an example of a virtualization layer 1302 located above a physical data center 1304. For the sake of illustration, the virtualization layer 1302 is separated from the data center 1304 by a virtual-interface plane 1306. The data center 1304 is an example of a distributed computing system. The data center 1304 comprises physical objects, including an administration computer system 1308, any of various computers, such as PC 1310, on which a virtual data center (“VDC”) management interface may be displayed to system administrators and other users, server computers, such as server computers 1312-1319, data-storage devices, and network devices. Each server computer may have multiple network interface cards (“NICs”) to provide high bandwidth and networking to other server computers and data storage devices. The server computers are networked together to form server-computer groups within the data center 1304. The example physical data center 1304 includes three server-computer groups each of which have eight server computers. For example, server-computer group 1320 comprises interconnected server computers 1312-1319 that are connected to a mass-storage array 1322. Within each server-computer group, certain server computers are grouped together to form a cluster that provides an aggregate set of resources (i.e., resource pool) to objects executing in the virtualization layer 1302.

The virtual-interface plane 1306 abstracts the resources of the physical data center 1304 to one or more VDCs comprising the virtual objects and one or more virtual data stores, such as virtual data store 1328. For example, one VDC may comprise the VMs running on server computer 1324 and virtual data store 1328. The virtualization layer 1302 includes virtual objects, such as VMs, applications, and containers, hosted by the server computers in the physical data center 1304. The virtualization layer 1302 may also include a virtual network (not illustrated) of virtual switches, routers, load balancers, and NICs formed from the physical switches, routers, and NICs of the physical data center 1304. Certain server computers host VMs and containers as described above. For example, server computer 1318 hosts two containers identified as Cont₁ and Cont₂; cluster of server computers 1312-1314 host six VMs identified as VM₁, VM₂, VM₃, VM₄, VMs, and VM₆; server computer 1324 hosts four VMs identified as VM₇, VM₈, VM₉, VM₁₀. Other server computers may host applications as described above with reference to FIG. 4. For example, server computer 1326 hosts an application identified as App₄.

For the sake of illustration, the data center 1304 and virtualization layer 1302 are shown with a small number of objects. In practice, a typical data center runs thousands of server computers that are used to run thousands of VMs and containers. Different data centers may include many different types of computers, networks, data-storage systems, and devices connected according to many different types of connection topologies described below.

Computer-implemented methods described herein are performed by an operations management server 1332 that is executed as a stand-alone application, in one or more VMs, or in containers on the administration computer system 1308. The operations management server 1332 provides several interfaces, such as graphical user interfaces (“GUIs”) described below, for users, such as data center management to system administrators and application owners to change parameters, to view results of the automated computer-implemented methods described herein and launch the execution of user-selected remedial measures to correct data center problems. The operations management server 1332 receives numerous streams of time-dependent metric data about the performance or usage of various objects and resources in the data center.

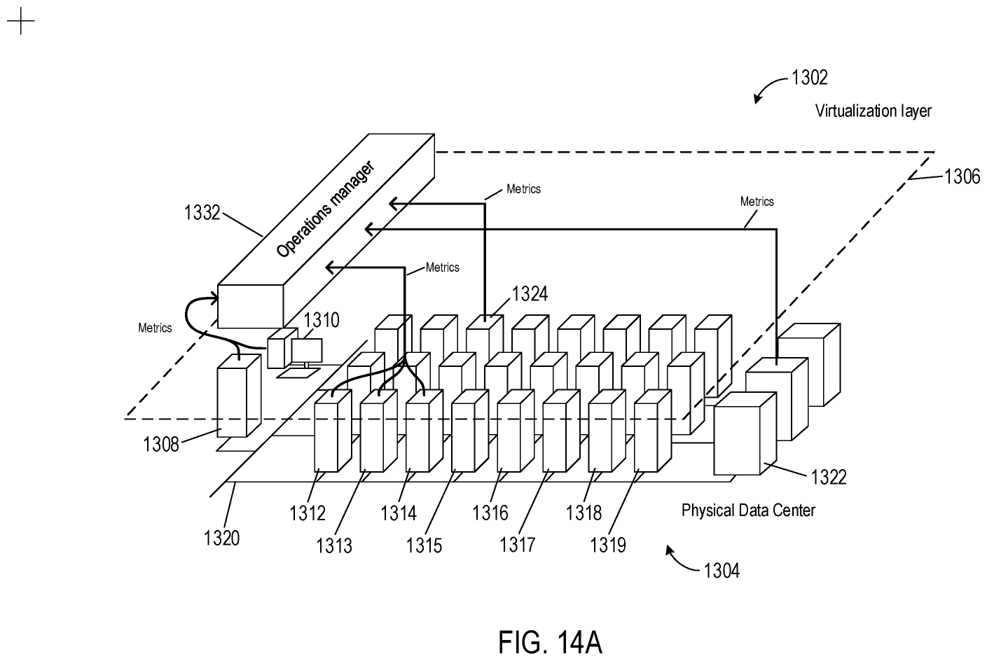

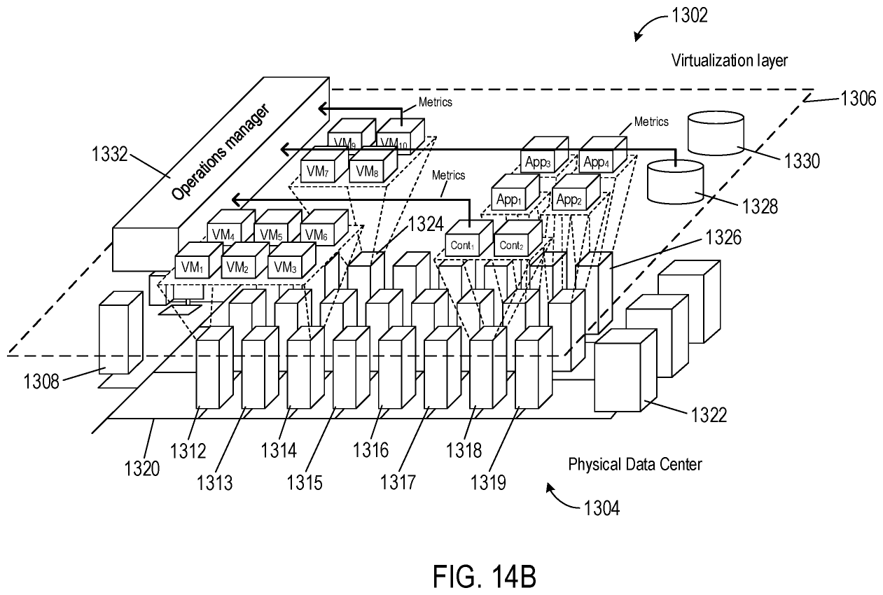

FIGS. 14A-14B show examples of operations performed by an operations management server receiving metrics from physical and virtual objects of the data center 1304. Directional arrows represent metrics sent from physical and virtual resources to the operations management server 1330. In FIG. 14A, the operating systems of PC 1310, server computers 1308 and 1324, and mass-storage array 1322 send metrics to the operations management server 1332. A cluster of server computers 1312-1314 send metrics to the operations management server 1332. In FIG. 14B, the VMs, containers, applications, and virtual storage May independently send metrics to the operations management server 1332. Certain objects may send metric values as the metric values are generated while other objects may only send metrics at certain times or when requested to send metrics by the operations management server 1332.

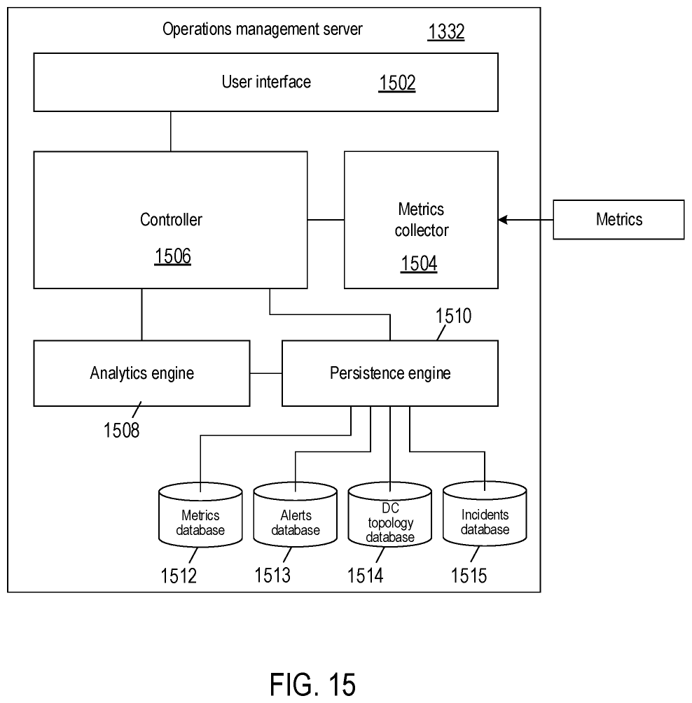

FIG. 15 shows an example architecture of the operations management server 1332. This example architecture of the operations management server 1332 includes a user interface 1502 that provides GUIs and user interface features for users, such as data center management, system administrators, and application owners, to receive alerts, clusters of alerts, and execute recommended remedial measures. The operations management server 1332 includes a metrics collector 1504 that receives streams of metrics from agents deployed at sources of metric data. The operations management server 1332 includes a controller 1506 that manages and directs the flow of metrics received by the metrics collector 1504. The controller 1506 manages the user interface 1502, executes instructions received via the user interface 1502, and controls the flow of information displayed by the user interface 1502. The controller 1506 directs the flow of metrics to the analytics engine 1508 and manages the computational operations performed by the analytics engine 1508 as described below. The analytic engine 1508 detects metric-level abnormalities for use in alerts and systems health assessments. The analytics engine 1508 monitors key performance indicators (“KPIs”) for problems with applications, maintains dynamic thresholds of metrics, generates alerts in real time when a metric or a KPI violates a corresponding threshold. The analytics engine 1508 performs the automated method of discovering incidents through clustering of alerts as described below. In other words, each cluster of alerts contains alerts that correspond to an incident occurring with object executing in the data center. The controller 1506 manages the low of output produced by the analytics engine 1508 to a persistence engine 1510, which stores data in, and retrieves information from, the databases 1512-1515 as described below.

Each stream of metric data received by the operations management server 1332 is time-series data that may be generated by an event source, such as an operating system, a resource, or by an object itself. A stream of metric data comprises a sequence of time-ordered metric values that are recorded in spaced points in time called “time stamps” and is stored in the metrics database 1512. A stream of metric data is simply called a “metric” and is denoted by

$${( {x}_{i} )}_{i = 1}^{N} = {( x ( {t}_{i} ) )}_{i = 1}^{N} \qquad ( 1 )$$

where
N is the number of metric values in a sequence of metric values;
xᵢ=x(tᵢ) is a metric value;
tᵢ is a time stamp indicating when the metric value was generated; and
subscript i is a time stamp index, i=1, . . . , N.

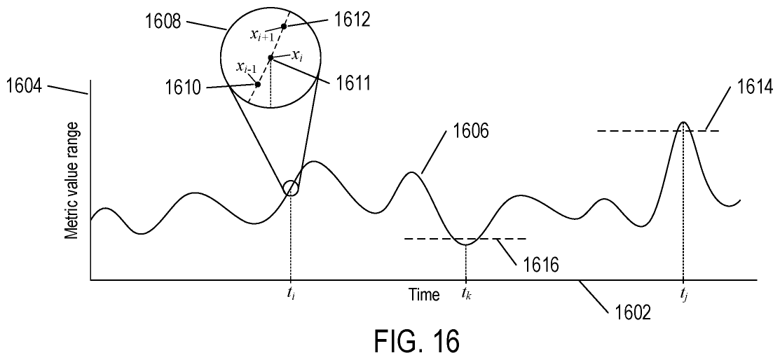

FIG. 16 shows a plot of an example metric. Horizontal axis 1602 represents time. Vertical axis 1604 represents a range of metric values. Curve 1606 represents a metric as time-series data. In practice, a metric comprises a sequence of discrete metric values in which each metric value is recorded in a data-storage device. FIG. 16 includes a magnified view 1608 of three consecutive metric values represented by points. Each point represents an amplitude of the metric at a corresponding time stamp. For example, points 1610-1612 represent consecutive metric values (i.e., amplitudes) xᵢ₋₁, xᵢ, and xᵢ₊₁ recorded in a data-storage device at corresponding time stamps tᵢ₋₁, tᵢ, and t_{i+1.}

Metrics represent different types of measurable quantities of physical and virtual objects of a data center and are stored in a metric database 1512 of a data storage appliance. A metric can represent CPU usage of a core in a multicore processor of a server computer over time. A metric can represent the amount of virtual memory a VM uses over time. A metric can represent network throughput for a server computer. Network throughput is the number of bits of data transmitted to and from a physical or virtual object and is recorded in megabits, kilobits, or bits per second. A metric can represent network traffic for a server computer or a VM. Network traffic at a physical or virtual object is a count of the number of data packets received and sent per unit of time. A metric may can represent object performance, such as CPU contention, response time to requests, and wait time for access to a resource of an object. Network flows are metrics that indicate a level of network traffic. Network flows include, but are not limited to, percentage of packets dropped, data transmission rate, data receiver rate, and total throughput.

The analytics engine 1508 constructs key performance indicators (“KPIs”) of application performance based on the metrics and stores the KPIs in the metrics database 1512. An application, for example, can have numerous associated KPIs. Each KPI is metric that represents the size, amount, or degree of object performance and is used by the analytics engine 1508 to detect performance problems. A KPI is a metric constructed from other metrics and is used as a runtime indicator of the health of an application executing in the data center. A distributed resource scheduling (“DRS”) score is an example of a KPI that is constructed from other metrics and is used to measure the performance level of a VM, container, or components of a distributed application. The DRS score is a measure of efficient use of resources (e.g., CPU, memory, and network) by an object and is computed as a product of efficiencies as follows:

$$x ( {t}_{i} ) = {EFFCY}_{CPU} ( {t}_{i} ) \times {EFFCY}_{Mem} ( {t}_{i} ) \times {EFFCY}_{Net} ( {t}_{i} ) \qquad ( 2 )$$

$$where$$

$${EFFCY}_{CPU} ( {t}_{i} ) = \frac{CPU usage ( {t}_{i} )}{Ideal CPU usage} ;$$

$${EFFCY}_{Mem} ( {t}_{i} ) = \frac{Memory usage ( {t}_{i} )}{Ideal Memory usage} ; and$$

$${EFFCY}_{Net} ( {t}_{i} ) = \frac{Network throughput ( {t}_{i} )}{Ideal Network throughput}$$

The metrics CPU usage (tᵢ). Memory usage (tᵢ), and Network throughput (tᵢ) of an object are measured at points in time as described above with reference to Equation (2). Ideal CPU usage, Ideal Memory usage, and Ideal Network throughput are preset. For example. Ideal CPU usage may be preset to 30% of the CPU and Ideal Memory usage may be preset to 40% of the memory. DRS scores can be used, for example, as a KPI that measures the overall health of a distributed application by aggregating, or averaging, the DRS scores of each VM that executes a component of the distributed application. Other examples of KPIs include average response times to client request, error rates, contention time for resources, or a peak response time. Other types of KPIs can be used to measure the performance level of a cloud application. A cloud application is a distributed application with data storage and logical components of the application executed in a data center and local components provide access to the application over the internet via a web browser or a mobile application on a mobile device. For example, a KPI for an online shopping application could be the number of shopping carts successfully closed per unit time. A KPI for a website may be response times to customer requests. KPIs may also include latency in data transfer, throughput, number of packets dropped per unit time, or number of packets transmitted per unit time.

Thresholds may be used to monitor metrics for events. An event is detected when one or more metric values violate an upper threshold 1614 denoted by:

$${x}_{j} \geq {Th}_{upper} \qquad ( 3 a )$$

where Thᵤₚₚₑᵣ is an upper threshold; and
   An event is detected when one or more metric values violates a lower threshold 1616 denoted by:

$${x}_{k} \leq {Th}_{lower} \qquad ( 3 b )$$

where Th_{lower} is a lower threshold.
   In one implementation, the thresholds in Equations (3a) and (3b) are time-independent thresholds. Time-independent thresholds can be determined for trendy and non-trendy randomly distributed metrics. In another implementation, the thresholds may be time-dependent, or dynamic, thresholds. Dynamic thresholds can also be determined for trendy and non-trendy periodic metric data. Time-independent thresholds may be determined as described in US Publication No. 2015/0379110A1, filed Jun. 25, 2014, which is owned by VMware Inc. and is herein incorporated by reference. Dynamic thresholds may be determined as described in U.S. Pat. No. 10,241,887, which is owned by VMware Inc. and is herein incorporated by reference.

The analytics engine 1508 detects events, or threshold violations, by comparing the runtime metric values to corresponding thresholds, as described above with reference to Equations (3a) and (3b). In response to detection of an event, the analytics engine 1508 generates an alert, indicating that an object or resource represented by the metric has entered an abnormal state. The controller 1506 stores the alerts in the alerts database 1513 and may display the alerts in the user interface 1502 of a systems administrator display screen.

The relationships and proximity between objects of a data center are represented by a data center topology hierarchy. A data center topology is a graph-based structure with data center objects represented by nodes that are in parent and child relationships, or ascendant/descendants in graph terminology. Parent child relationships between objects are represented by edges that connect nodes.

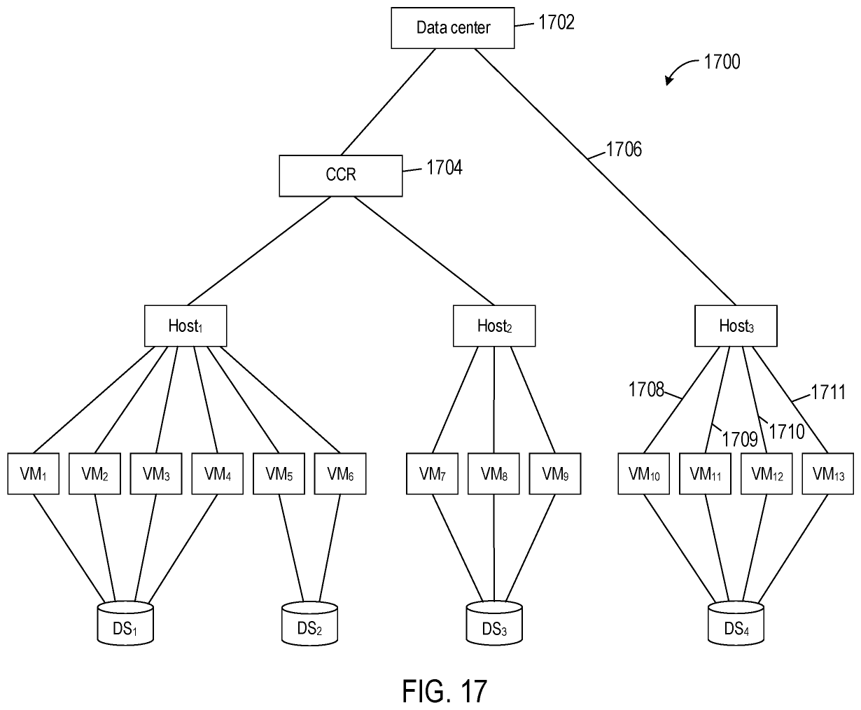

FIG. 17 shows an example data center graph 1700 that represents the topology hierarchy of data center objects. Each object of the data center is represented by a node. The example graph has a root node 1702 that represents the data center itself. The nodes include a cluster compute resource (“CCR”) 1704 that collects configuration and summary properties for cluster compute resource objects. Three nodes represent hosts denoted by Host₁, Host₂, and Host₃. Thirteen nodes represent thirteen VMs denoted by VMᵢ, where i=1, . . . , 13. Four nodes represent datastores denoted by DS₁, DS₂, DS₃, and DS₄. Nodes connected by edges represent relationships between objects. For example, edge 1706 indicates that Host₃ runs in the data center. Edges 1708-1711 indicate that VM₁₀, VM₁₁. VM₁₂, and VM₁₃ are hosted by Host₃. Edges 1712-1714 indicate that VM₇. VM₈, and VM, utilize datastore DS₃ for data storage. The data center topology is stored in the data center topology database 1514.

A data center graph is a representation of the topological hierarchy of data center objects associated with different layers of the data center graph. Objects of a layer of objects located farther away from the root node than another layer of objects have a lower rank than objects in the layer located closer to the root node. For example, in FIG. 17, the data center node 1702 is the root node and has the highest rank of the data center objects. The CCR 1704 is a lone object in the second layer and has the second highest rank. The hosts are in a third layer and have the third highest rank. The VMs are in the same layer and have the fourth highest rank. The datastores are in the fifth layer and have the fifth highest rank.

A typical adverse incident (i.e., incident) in a data center corresponds to related alerts that have a strong time-dependent component and a topological proximity component. For example, alerts that occur close in time are more likely to be related than alerts that occur with greater time separation. In addition, alerts associated with objects and resources that are located in close topological proximity to one another in a data center topology are more likely to be related than are alerts associated with objects located farther away from each other in the data center topology. For example, in FIG. 17, VM₁₀ is in closer topological proximity to the Host₃ than to Host₁. Topological proximity of two objects in the data center graph is measured by number of edges separating the objects and is referred to in units of “hops.” For example, in FIG. 17, VM₁ is one hop away from Host₁ and is three hops away from the data center node 1702. VMs VM₁₀ and VM₁₁ are separated by two hops (i.e., edges 1708 and 1709).

Because many objects running in a typical data center share multiple resources, exchange data, rely on many of the same networks, and depend on the performance of other objects also running in the data center, problems with a few objects or resources can quickly increase into multiple problems that adversely affect the performance of numerous objects running in the data center. As a result, the number of alerts generated in a short period of time, such as minutes to just a few hours, can reach into the thousands, making it impossible for system administrators to track the events that triggered the alerts, identify which of the events are related events, and apply appropriate remedial measures. A system administrator or application owner presented with a list of alerts in a GUI on a system console or monitor has no way of knowing how the events that created the alerts are related and which events are isolated incidents. The methods and systems executed by the operations management server 1332 described below solve this problem by identifying clusters of alerts that are related in time and topological proximity and identify the alerts within the clusters of alerts that correspond to incidents. An incident is a group of alerts that are related in time, topological proximity, and correspond to related event types as explained below.

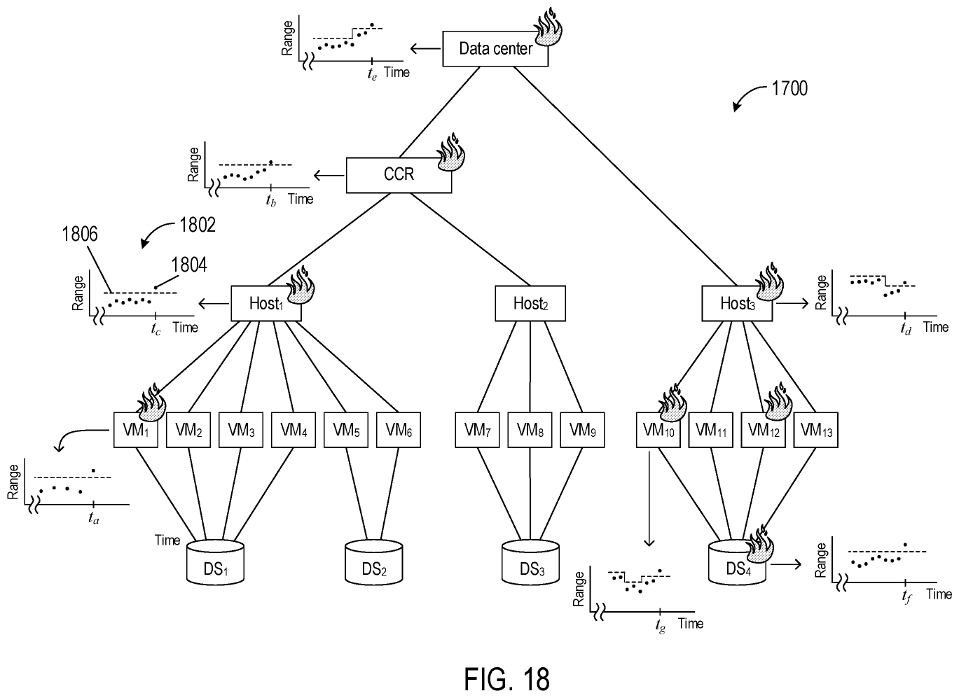

FIG. 18 shows an example of objects of the data center graph 1700 in which objects experience events that trigger alerts. Flames mark objects that are experiencing abnormal behavior. Plots of metrics located adjacent to objects include threshold violations that trigger corresponding alerts. For example, plot 1802 represents a metric of a resource of the Host₁. In this example, metric value 1804 violates corresponding threshold 1806 at time t_{c} which triggers an alert. Each of the alerts is recorded in the alerts database 1513 by the analytics engine 1508.

FIG. 19 shows an example of alert information recorded in the alerts database 1513. Table 1902 includes a column 1904 that identifies the alert (“ID”), column 1905 identifies the start time of the event that triggered the alert, column 1906 identifies the resource of the object experiencing the event, column 1907 identifies the object itself. The alerts correspond to the alerts and start times in FIG. 18. For example, row 1908 identifies the name of the alert denoted by A₃, time of the alert t_{c}, resource R_{c} that experienced the event, and object name, which is Host₁ in FIG. 18. The resource represented by R_{c} could be the CPU, memory, or data storage device of Host₁. Entries in columns 1905-1907 comprise the alert information. Entries in columns 1909 and 1910 are determined by the clustering methods described below.

A single alert corresponds to a single event. Numerous alerts correspond to numerous events. However, examination of alerts alone does not reveal if the events are part of a single incident or multiple separate incidents in the data center. For example, two alerts may occur close in time but are separated by more than three hops in the data center topology. In this case, the alerts may just be a coincidence and may be associated with events that are not related to one another. Alternatively, two alerts may occur with close topological proximity in the data center topology but are separated by a significant time difference. In this case, the alerts may have been triggered by entirely different unrelated events.

A data center incident is composed of a group of two or more alerts that are close in time and topological proximity (i.e., belong to the same cluster) and have related event types. Topological proximity refers to the number of hops between objects in a data center topological hierarchy. The analytics engine 1508 performs automated methods of discovering clusters of alerts in streaming events. The individual alerts in a cluster are evaluated based on user feedback of previous alerts to determine whether the event types of the alerts are related and stem from the same problem.

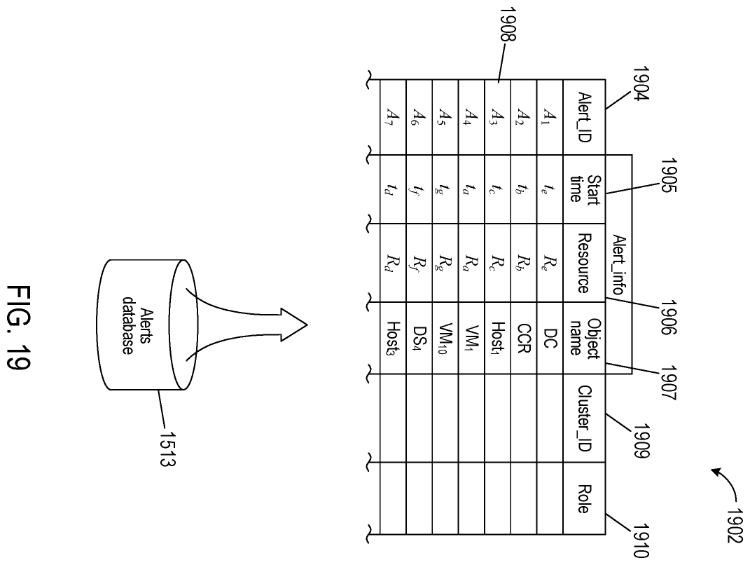

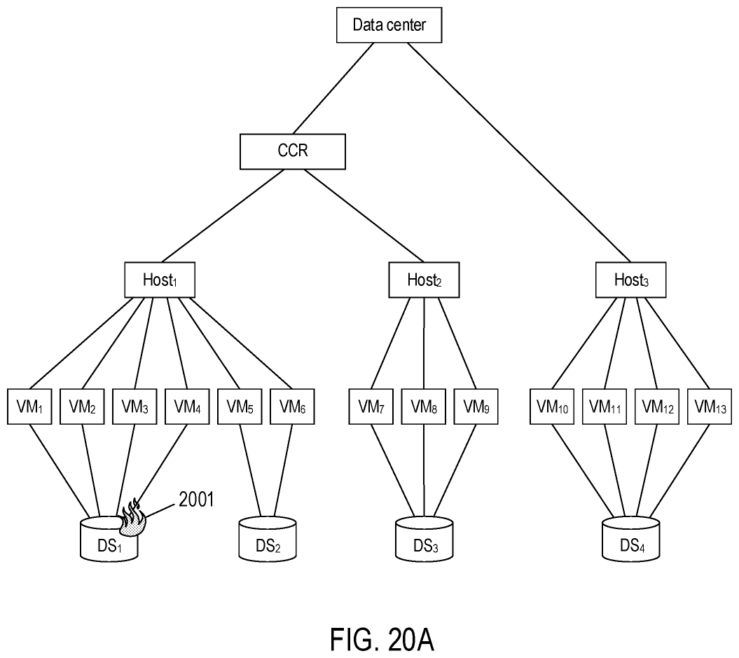

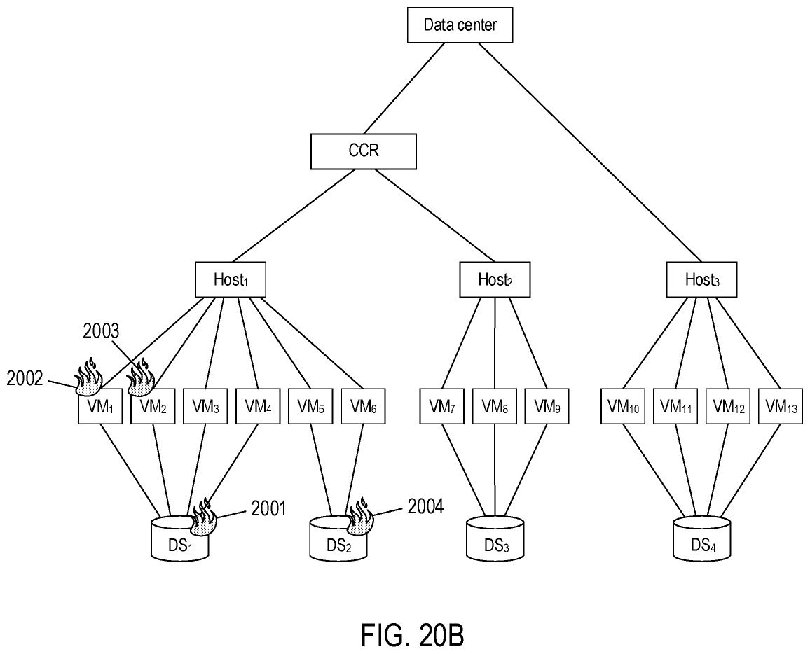

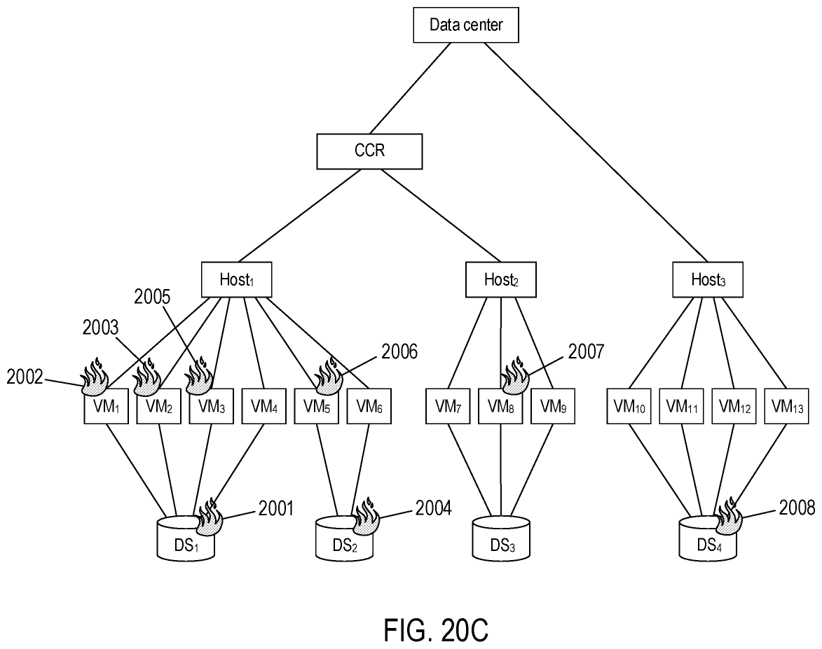

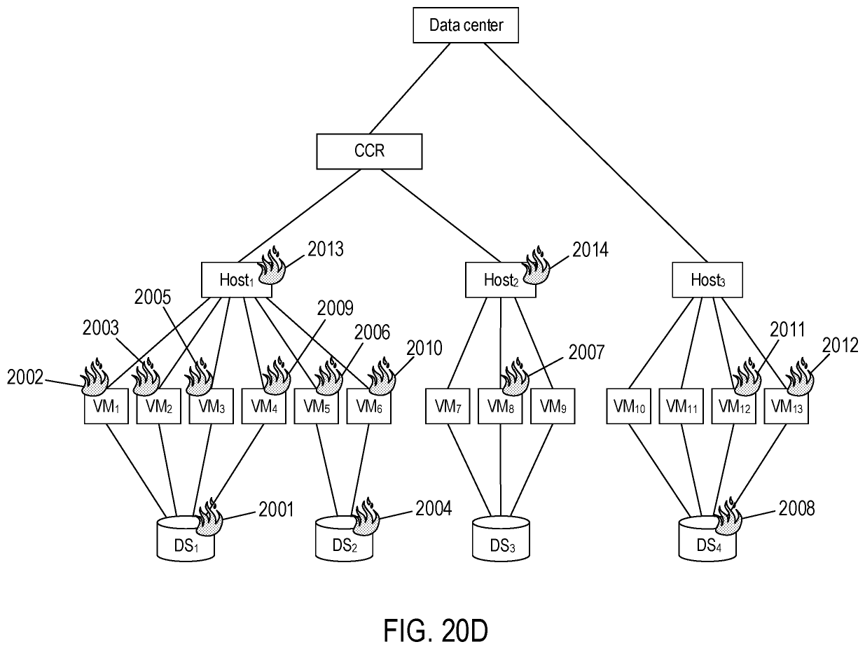

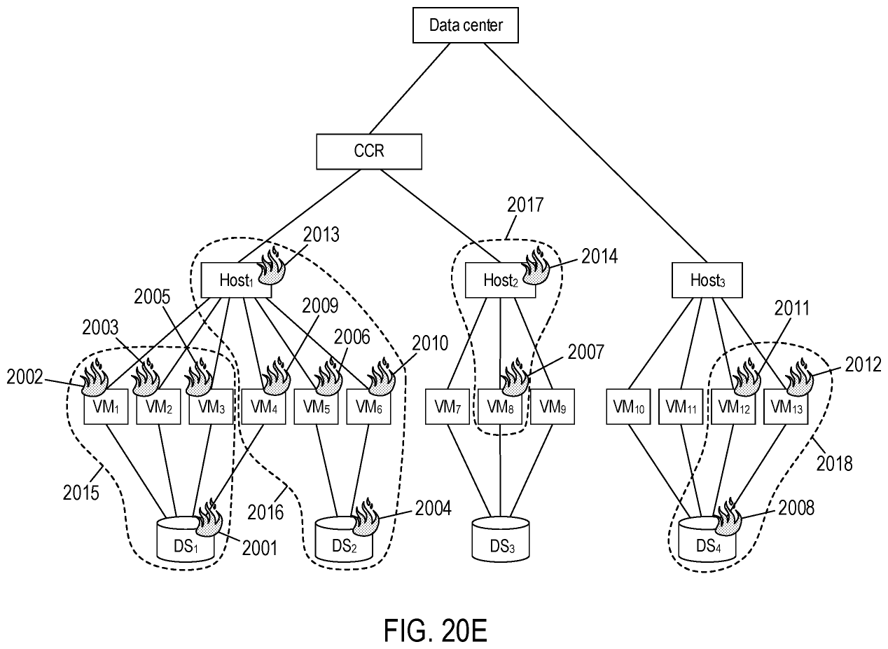

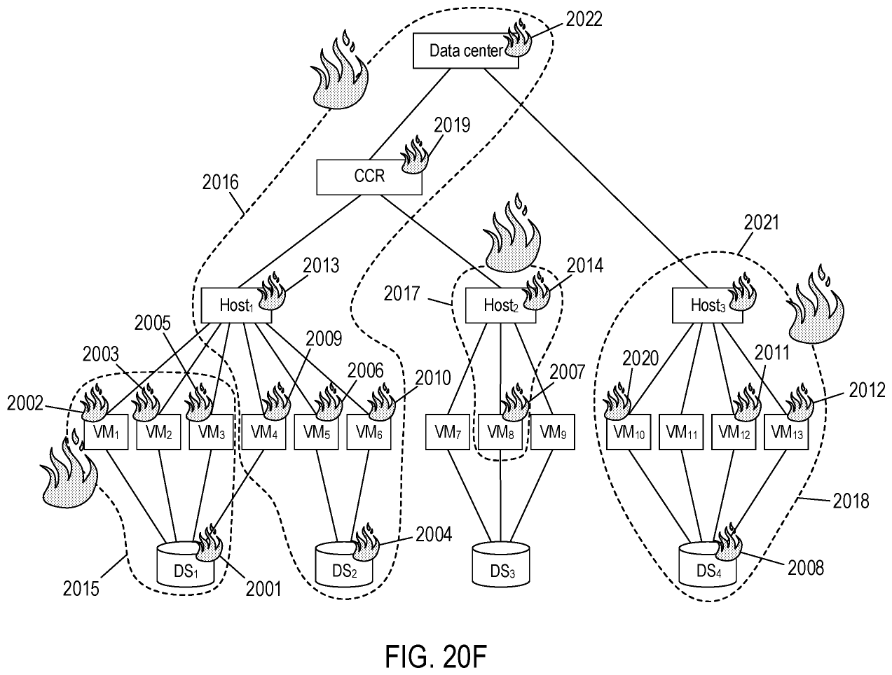

FIGS. 20A-20F show an example of time evolution of alerts triggered by related and unrelated events in a stream of events occurring in the objects of the data center 1700. Each figure displays alerts that are generated at about the same time. In FIG. 20A, an alert 2001 is triggered by an event on datastore DS₁, which is soon followed by alerts 2002 and 2003 triggered by events on VMs VM₁ and VM₂, respectively, and an alert 2004 triggered by an event on datastore DS₂ in FIG. 20B. In FIG. 20C, three additional alerts 2005-2008 are triggered on VMs VM₃, VM₄, and VMs and on datastore DS₄, respectively. In FIG. 20D, alerts 2009-2012 are triggered on VMs VM₄, VM₆, VM₁₂, and VM₁₃, respectively, and alerts 2013 and 2014 are triggered on hosts Host₁ and Host₂. As alerts are generated, the analytics engine 1508 performs automated discovery of clusters of alerts as described below. In FIG. 20E, dashed enclosures 2015-2018 identify clusters of alerts that are related in time and topological proximity. For example, the cluster 2015 is composed of alerts 2001-2003, and 2005 that are close in time and topological proximity. Cluster 2017 is composed of alerts 2007 and 2014 that are close in time and topological proximity. Note that alerts 2001 and 2004 occur close in time but are not close in topological proximity. As a result, alerts 2001 and 2004 are not part of the same cluster. In addition, alert 2013 occurs with the same topological proximity to the alerts 2002, 2003, and 2005 as to the alerts 2006, 2009, and 2010. But the alert 2013 occurs closer in time to the alerts 2006, 2009, and 2010. As a result, the alert 2013 is added to the cluster 2016. In FIG. 20F, an alert 2019 is triggered by an event on the CCR, an alert 2020 is triggered by an event on VM₁₀, and an alert 2021 is triggered by an event on Host₃. The alert 2019 is close in time and topological proximity to the alert 2013 and is therefore added to the incident 2016. The alerts 2020 and 2021 are close in time and topological proximity to the alerts 2008, 2011, and 2012 and are therefore added to the incident 2018. In FIG. 20F, an alert 2022 triggered by an event in the data center is close in time and topological proximity to the alert 2019 and is added to the cluster 2016.

Clustering methods employ a two-part distance measure in terms of time and topological proximity to detect clusters of alerts. Consider two alerts A(tᵢ, Rᵢ) and A(tⱼ, Rⱼ), where tᵢ and tⱼ are start times, and Rᵢ and Rᵢ are resources of two data center objects. The time difference between the alerts is distₜ(tᵢ, tⱼ)=|tⱼ−tᵢ|. The number of hops between resources Rᵢ and Rⱼ is dist_{K}(Rᵢ, Rⱼ)=No. of hops. The clustering methods perform clustering of alerts based on the number of alerts that are in neighborhoods of the alerts. A neighborhood of an alert A(tᵢ, Rᵢ), denoted by N_{ϵ}(A(tᵢ, Rᵢ)), is defined by

$${N}_{ϵ} ( A ( {t}_{i} , {R}_{i} ) ) = \{ A ( {t}_{j} , {R}_{j} ) ∈ D \vert {dist}_{t} ( {t}_{i} , {t}_{j} ) \leq {T}_{ϵ} and {dist}_{K} ( {R}_{i} , {R}_{j} ) \leq {K}_{ϵ} \} \qquad ( 4 )$$

where
T_{ϵ} is a fixed time limit; and
K_{ϵ} is a limit on the number of hops separating the two alerts.
   A neighborhood of an alert contains alerts that start with start time differences that are less than time, T_{ϵ}, and refer to objects that are located on the data center graph topology in less than or equal to, K_{ϵ}, hops. The number of alerts in a neighborhood of an alert is given by ∥N_{ϵ}(A(tᵢ, Rᵢ))∥. ∥⋅∥ denotes cardinality of a set of alerts. An alert is identified as a core alert of a cluster of alerts, a border alert of a cluster of alerts, or a noise alert based on the number of alerts that lie within the neighborhood of the alert. Let MinPts represent a user selected minimum number of alerts for a core alert. An alert A(tᵢ, Rᵢ) is a core alert of a cluster of alerts when N_{ϵ}(A(tᵢ, Rᵢ))∥≥MinPts. An alert A(tᵢ, Rᵢ) is a border alert of a cluster of alerts when MinPts>∥N_{ϵ}(A(tᵢ, Rᵢ))∥>1 and contain at least one core alert in addition to the alert A(tᵢ, Rᵢ). An alert A(tᵢ, Rᵢ) is noise when ∥N_{ϵ}(A(tᵢ, Rᵢ))∥=1 (i.e., when the neighborhood contains only the alert A(tᵢ, Rᵢ)).

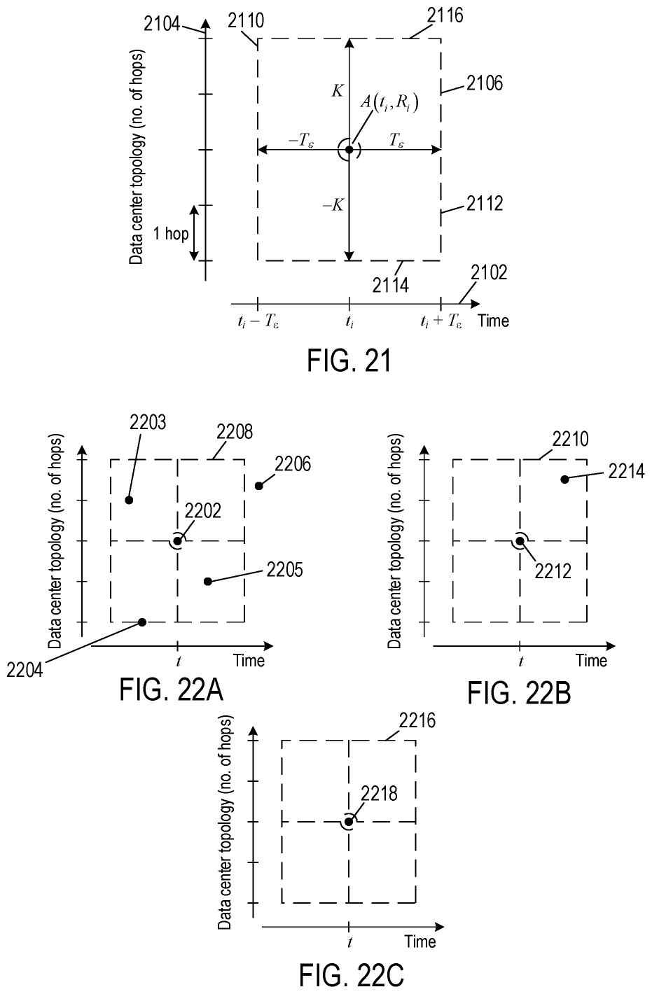

FIG. 21 shows an example of a neighborhood of an alert A(tᵢ, Rᵢ). Horizontal line 2002 represents a time axis. Vertical line 2104 represents a range of hops between objects in a data center graph. Solid dot 2106 represents the alert A(tᵢ, Rᵢ) with start time tᵢ located along the time axis 2102. Dashed rectangle 2108 represents boundaries of a neighborhood N_{ϵ}(A(tᵢ, Rᵢ)) centered at the location of the alert A(tᵢ, Rᵢ). In this example illustration, the fixed time limit T_{ϵ} corresponds to vertical sides 2110 and 2112. The limit on the number of hops is set to 2 (i.e., K_{ϵ}=2) as represented by horizontal sides 2114 and 2116. An alert A(tⱼ, Rⱼ) is an element of the neighborhood N_{ϵ}(A(tᵢ, Rᵢ)) if tᵢ−T_{ε}≤tⱼ≤tᵢ+T_{ε} and dist_{K}(Rᵢ, Rⱼ) is less than or equal to two hops.

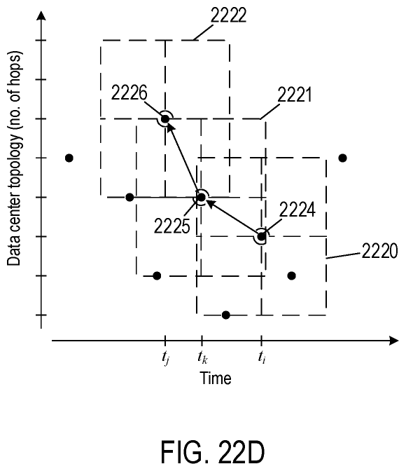

FIGS. 22A-22C show examples of a core alert, a border alert, and noise, respectively. In this example, the minimum number of alerts for a core alert is set to 3 (i.e., MinPts=3). In FIG. 22A, five alerts 2202-2206 are represented by solid points. Rectangle 2208 represents the boundaries of the neighborhood of the alert 2202. The neighborhood 2208 contains 4 alerts, which is greater than MinPts. As a result, the alert 2202 is a core alert because the alerts 2203-2205 lie within the neighborhood 2208. In FIG. 22B, rectangle 2210 represents the boundaries of a neighborhood of the alert 2112. The alert 2212 is a border alert because the neighborhood 2210 contains the two alerts 2212 and 2214, where the alert 2214 is a core point, and the number of points in the neighborhood is less than MinPts and is greater than 1. In FIG. 22C, rectangle 2216 represents the boundaries of a neighborhood of the alert 2218. The alert 2218 is noise because the neighborhood 2216 contains the single alert 2218.

An alert A(tᵢ, Rᵢ) is directly density-reachable from an alert A(tⱼ, Rⱼ) if A(tᵢ, Rᵢ)∈N_{ϵ}(A(tⱼ, Rⱼ)) and A(tⱼ, Rⱼ) is a core alert (i.e., ∥N_{ϵ}(A(tⱼ, Rⱼ))∥≥ MinPts). In FIG. 22A, the alert 2203 is directly density-reachable from the alert 2202 because the alert 2203 lies within the neighborhood 2208 and the neighborhood contains more alerts than MinPts=3.

An alert A(tᵢ, Rᵢ) is density reachable from an alert A(tⱼ, Rⱼ) if there is a chain of alerts A(t₁, R₁), . . . , A(tₙ, Rₙ), A(tᵢ, Rᵢ)=A(t₁, R₁), A(tⱼ, Rⱼ)=A(tₙ, Rₙ) such that A(tₖ₊₁, Rₖ₊₁) is directly density-reachable from A(tₖ, Rₖ) for k=1, . . . , n. FIG. 22D shows an example of a density reachable alert. Neighborhoods 2220-2222 are centered at alerts 2224-2226, respectively. Alert 2226 is density reachable from the alert 2224 because there is an intermediate alert 2225 that is directly density-reachable from the alert 2224 and the alert 2226 is directly density-reachable from the alert 2225.

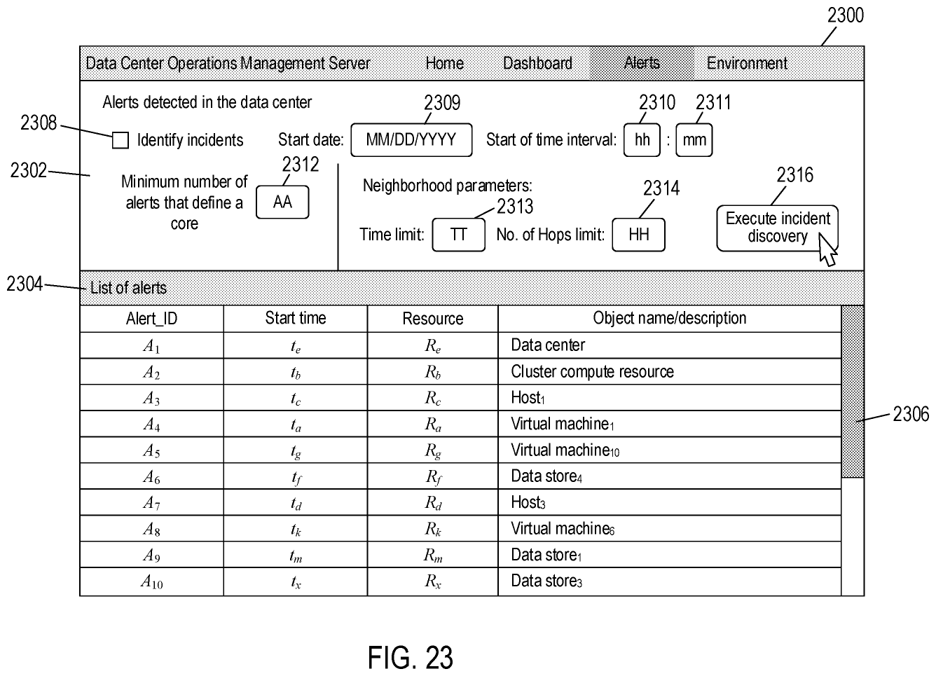

FIG. 23 shows an example graphical user interface (“GUI”) 2300 of the user interface 1502 of the operations management server 1332. The GUI 2300 enables a user to execute the process of identifying cluster of alerts in a stream of events occurring in a data center as described below. The GUI 2300 retrieves alerts associated with a stream of events from the alerts database 1513. In this example, the GUI 2300 includes an “Alerts” tab that when clicked on displays pane 2302 with fields for entering parameters and executing the processes described below for detecting clusters of alerts in the data center. GUI 2300 includes pane 2304 that displays a list of alerts associated with events occurring with data center objects. Pane 2304 includes a scroll bar 2306 that enables a user to scroll through the various alerts. However, the user has no way of knowing from simply scrolling through the alerts which alerts are part of the same incident and which alerts are noise. In this example, pane 2302 includes a field 2308 that when clicked on enables the fields 2309-2314 for user input. The user enters a start date in field 2309 and time in fields 2310 and 2311 (i.e., current time t_{cur}). The user enters a minimum number of alerts (i.e., MinPts) that define a core alert in field 2312 and enters a time limit (i.e., T_{ε}) in field 2313 and number of hops limit (i.e., Kg) in field 2314 for a neighborhood. Once the parameters are entered in the fields 2309-2314, the user clicks on button 2316 to execute the automated process of discovering clusters of alerts in the data center described below.

Given MinPts, T_{ε}, and K_{ε}, a cluster of alerts can be discovered by first selecting a core alert as a seed and retrieving all alerts that are density reachable from the seed obtaining the cluster containing the seed. In other words, consider an arbitrarily selected core alert. Then the set of alerts that are density reachable from the core alert is a cluster of alerts. Each cluster of alerts contains alerts that may represent related event types occurring with objects executing in the data center.

The analytics engine 1508 identifies clusters of alerts in a stream of runtime alerts based on the minimum number of points MinPts and the time and proximate topology parameters (T_{ε}, K_{ε}). Let t_{cur} denote the current time. Clusters of runtime alerts are identified in a sliding runtime window that ends at the current time t_{cur} and begins at a time t_{cur}−Γ, where Γ is the duration of the runtime window. For example, the duration Γ can be set to any suitable time length. The analytics engine 1508 partitions the duration of the time window into N equal duration time intervals, where N is greater than three, and the duration of the intervals Δ=Γ/N. For example, if the duration of the runtime window is set to 60 minutes and N is set to 4, the time intervals are each 15 minutes. In the following examples, the runtime window 2208 is partitioned into four equal length intervals identified as Interval_1, Interval_2, Interval_3, and Interval_4, where Interval_1 is the earliest interval, Interval_2 is the second earliest interval, Interval_3 is the third earliest interval, and Interval_4 is the latest interval.

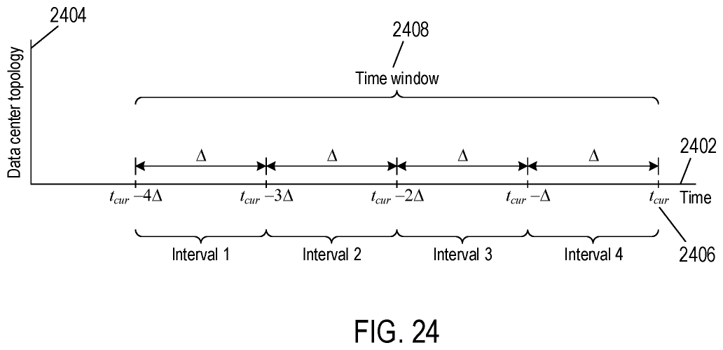

FIG. 24 shows an example of a runtime window partitioned into four equal duration time intervals. Horizontal line 2402 represents a time axis. Vertical axis 2404 represents the distance between objects in the data center topology in terms of number of hops. The current time t_{cur} 2406 is marked along the time axis. The runtime window 2408 is partitioned into four equal duration time intervals, each with a duration denoted by Δ.

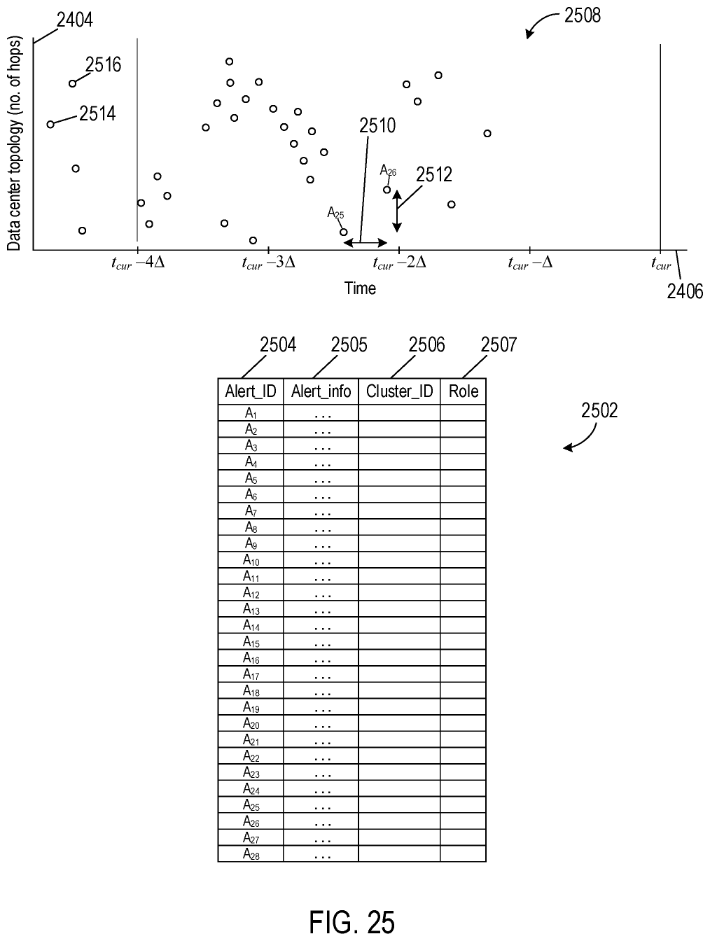

The analytics engine 1508 retrieves alerts with start times from the alerts database 1513 in the runtime window 2408. FIG. 25 shows a data table 2502 that represents 28 alerts with start times in the runtime window retrieved from the alerts database 1513. Column 2504 lists the alert IDs of the 28 alerts. Column 2505 list the alert information of each alert as described above with reference to FIG. 19. Ellipses are used to represent the alert information. For example, the alert information of the alert A₁ may be a CPU threshold violation on a first host; the alert information of the alert A₂ may be a memory threshold violation on the first host; and alert information of the alert A₃ may be a network failure on a second host. Columns 2506 and 2507 list blank entries for cluster identification (“cluster ID”) and the role each alert has in the clusters, respectively. The cluster ID can be a name or an alphanumeric term or word. The automated method described below determines the cluster each alert belongs to and the role each alert has in the cluster. For the sake of illustration, FIG. 25 also shows an example plot 2508 of the alerts listed in table 2502. Open dots represent the alerts and enable a visual representation of relative time difference and topological distance in terms of hops between alerts. For example, directional arrow 2510 represents the time difference between the alerts A₂₅ and A₂₆, and directional arrow 2512 represents the number of hops between objects in the data center topology with the alerts A₂₅ and A₂₆. Note that alerts occurring before the start of the runtime window at t_{cur}−4Δ, such as alerts 2514 and 2516, are not included in the clustering process.

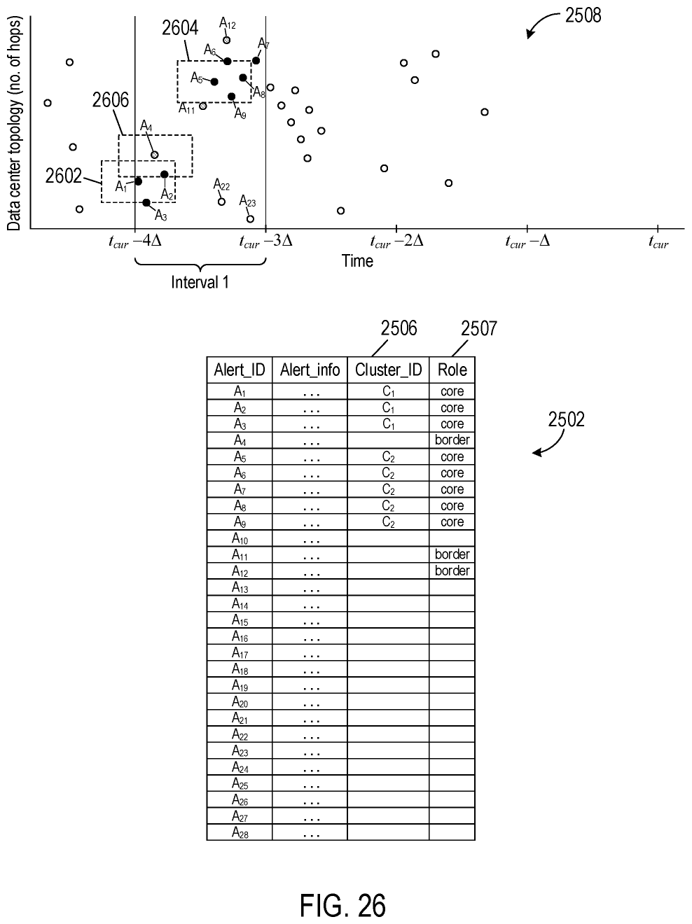

FIGS. 26-32 show a process of detecting clusters of the alerts based on a MinPts=3 and values selected for T_{ε}, and K_{ε}. The process begins by detecting core alerts in the earliest interval Interval_1. The analytics engine 1508 detects core alerts by counting the number of alerts located within the neighborhood of each alert in Interval_1. Each alert with three or more alerts in the neighborhood of the alert is tagged as a core alert. The analytics engine 1508 assigns the core alerts to clusters of alerts.

FIG. 26 shows an example of core alerts and border alert in the earliest interval Interval_1. Each of the alerts is shown with a corresponding alert ID. Core alerts are identified by dark shading. Border alerts are shown in gray shading. FIG. 26 shows an example of a neighborhood 2602 centered on alert A₁. The alerts A₂ and A₃ are located within the boundaries of the neighborhood 2602. The neighborhood 2602 of the alert A₁ contains 3 alerts. As a result, the alert A₁ is identified as a core alert. Alerts A₂ and A₃ are also core alerts with associated neighborhoods that contain 3 or more alerts. FIG. 26 shows an example of a neighborhood 2604 centered on alert A₅. The alerts A₆, A₈, and A₉ are located within the boundaries of the neighborhood 2604. The neighborhood 2606 of the alert A₄ contains 4 alerts. As a result, the alert A₄ is identified as a core alert. Alerts A₆, A₇, A₈, and A₉ are also core alerts with associated neighborhoods that contain 3 or more alerts. The alerts identified as core alerts in the Interval_1 are labeled as core alerts in column 2507 of the data table 2502. The neighborhood 2604 of the alert A₄ contains 2 alerts and is identified as a border alert. Similarly, the alerts A₁₁ and A₁₂ are identified as border alerts because the neighborhoods of the alerts A₁₁ and A₁₂ only contain 2 alerts. The alerts identified as border alerts in the Interval_1 are labeled as border alerts in column 2507 of the data table 2502. The core alerts A₁, A₂, and A₃ form a first cluster identified as C₁. For example, each of the core alerts is density reachable from one of the other core alerts. In column 2506, the core alerts A₁, A₂, and A₃ are labeled as C₁. None of the alerts A₅, A₆, A₇, A₈, and A₉ are located in a neighborhood of the alerts of the cluster C₁ and vis-à-vis. As a result, a second cluster identified as C₂ is formed from the alerts A₅, A₆. A₇, A₈, and A₉. Each of the core alerts is density reachable from one of the other core alerts. In column 2506, the alerts A₅, A₆, A₇, A₈, and A₉ are labeled as C₂.

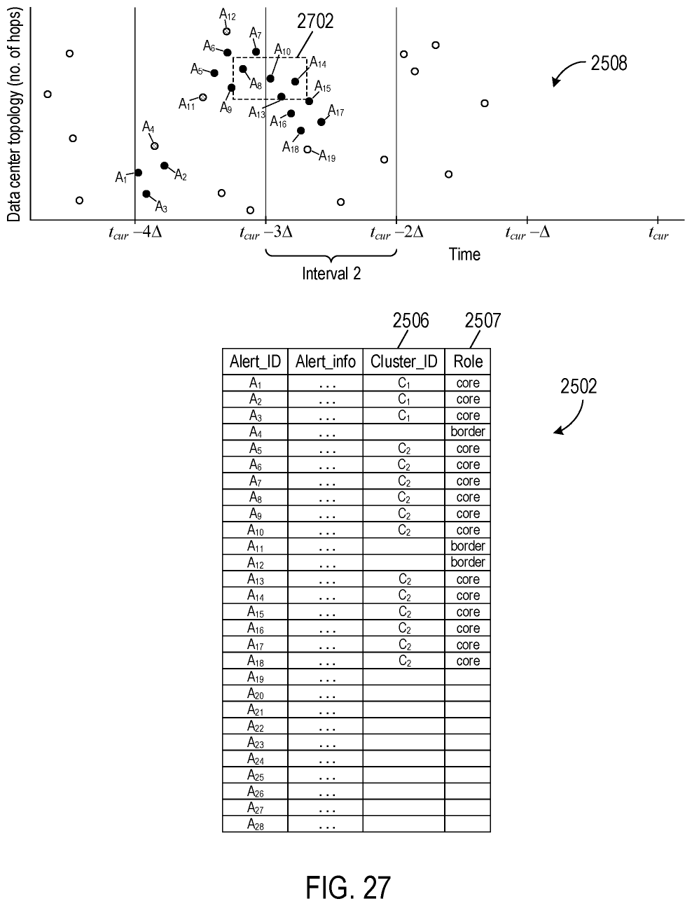

The analytics engine 1508 detects core alerts in the second earliest interval Interval_2. FIG. 27 shows an example of core alerts and a border alert identified in the second earliest interval Interval_2. Each of alerts is labeled with the alert ID. Core alerts are identified by dark shading. FIG. 27 shows an example of a neighborhood 2702 centered on alert A₁₀, which contains more than 3 alerts within the neighborhood boundaries. As a result, the alert A₁₀ is identified as a core alert. Similarly, alerts A₁₃, A₁₄, A₁₅, A₁₆, A₁₇, and A₁₈ are also core alerts with associated neighborhoods that contain 3 or more alerts. The alerts A₁₀, A₁₃, A₁₄, A₁₅, A₁₆. A₁₇, and A₁₈ identified as core alerts in column 2507 of the data table 2502.

For each core alert in the Interval_2, there are three possible scenarios for determining the cluster ID of a core alert:

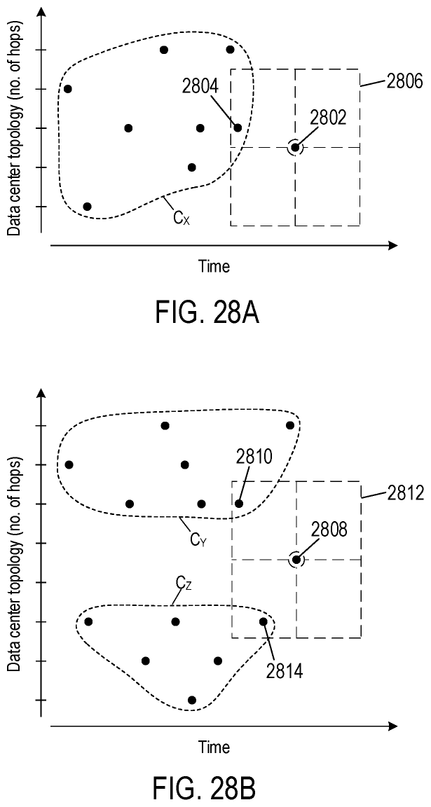

1.) The neighborhood of the core alert contains a core alert already assigned a cluster ID. In this case, a core alert is assigned to the cluster ID of the neighboring core alert. FIG. 28A shows an example of a new core alert 2802. Core alert 2804 belongs to a cluster of alerts C_{X} and is in the neighborhood 2806 of the core alert 2802. As a result, new core alert 2802 is assigned to the cluster C_{X}.

2.) The neighborhood of the core alert contains more than one core alert, each having a different cluster ID. In this case, the clusters of the core alerts already having clusters IDs are merged. The core alert is assigned the cluster ID of the core alert in a cluster with the most core alerts. The core alerts of the cluster with fewer core alerts are assigned the cluster ID of the cluster with the most core alerts. FIG. 28B shows an example of new core alert 2808. Core alert 2810 belongs to a cluster of alerts C_{Y} and is in the neighborhood 2812 of the core alert 2808. Core alert 2814 belongs to a cluster of alerts C_{Z} and is also in the neighborhood 2812 of the core alert 2808. Because the cluster C_{Y} has more core alerts than the cluster C_{Z}, the core alert 2808 is assigned the cluster ID of the cluster C_{Y} and the cluster C_{Z} is merged with the cluster C_{Y} by assigning the cluster ID of the cluster C_{Y} to the core alerts of the cluster C_{Z}.

3.) The neighborhood of the core alert does not contain a core alert with a cluster ID. In this case, a new cluster ID is assigned to the core alert.

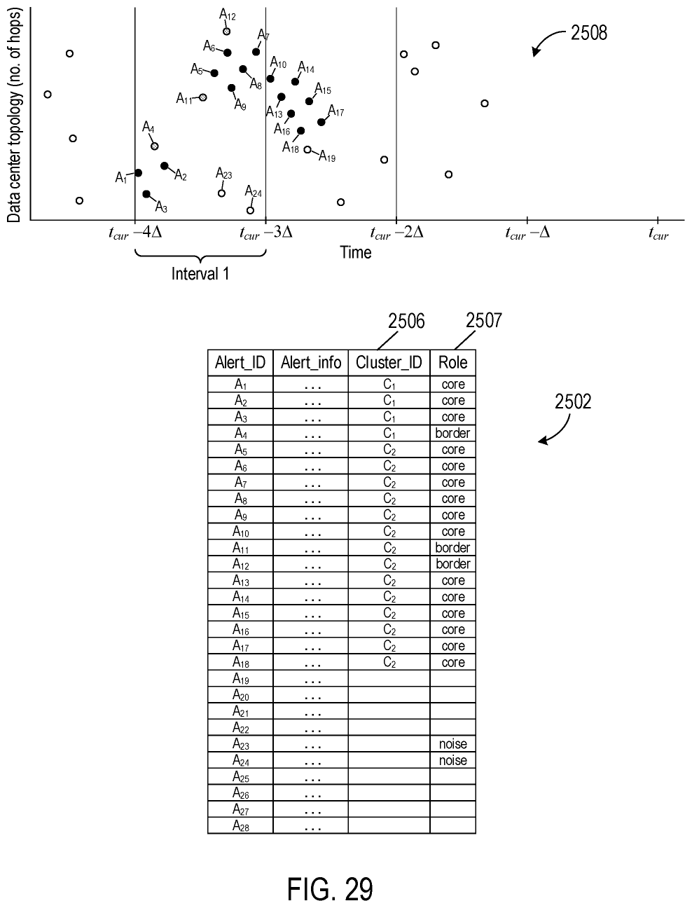

Returning to FIG. 29, the neighborhood 2502 of core alert A₁₀ contains the core alert A₈ of the cluster with cluster ID C₂. According to scenario 1.), core alert A₁₀ is assigned the cluster ID C₂. Because core alerts A₁₃, A₁₄, A₁₅, A₁₆, A₁₇, and A₁₈ are density reachable from the core alert A₁₀, the core alerts A₁₃, A₁₄, A₁₅, A₁₆, A₁₇, and A₁₈ are also assigned the cluster ID C₂. In column 2506, the core alerts A₁₀, A₁₃, A₁₄, A₁₅, A₁₆, A₁₇, and A₁₈ are assigned the cluster ID C₂.

The analytics engine 1508 assigns cluster IDs to border alerts in the earliest interval Interval_1. As described above with reference to FIG. 29, alerts A₄, A₁₁, and A₁₂ were identified as border alerts, but were not assigned a cluster ID. An alert in the earliest interval Interval_1 that does not contain another alert in the neighborhood of the alert is identified as noise. Noise alerts are not part of a cluster of alerts and are considered isolated events.

In FIG. 29, the border alert A₄ is density reachable from any one of alerts in the cluster C₁. As a result, the border alert A₄ is labeled with cluster ID C₁ in column 2507 of the data table 2502. The border alerts A₁₁ and A₁₂ are density reachable from any one of the alerts in the cluster C₂. As a result, the border alerts A₁₁ and A₁₂ are labeled with cluster ID C₂ in column 2507 of the data table 2502. In FIG. 29, neighborhoods of the alerts A₂₃ and A₂₄ do not contain additional alerts and are identified as noise. The alerts A₂₃ and A₂₄ are labeled as noise in column 2507.

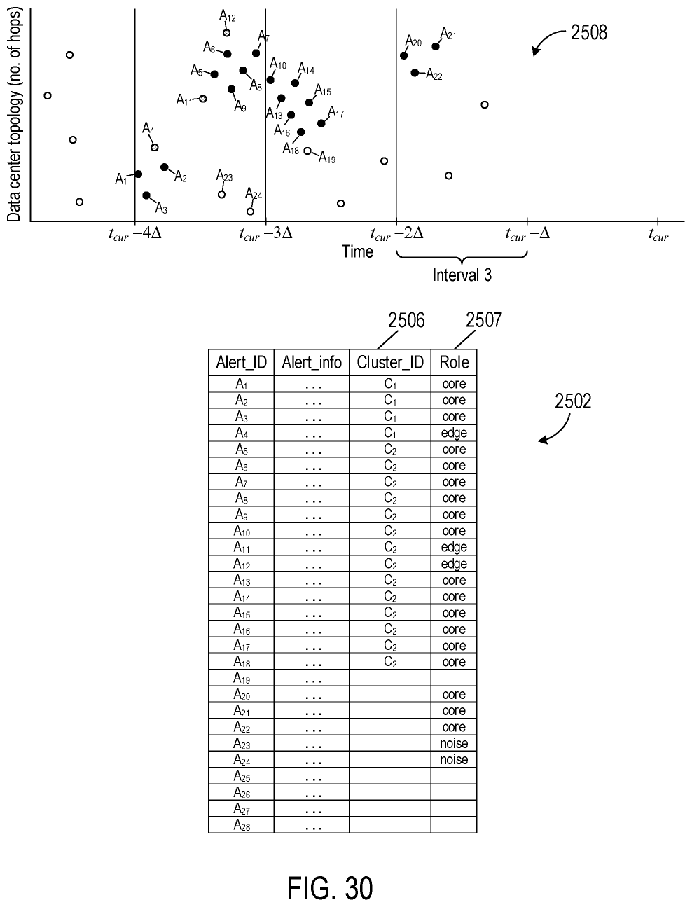

The analytics engine 1508 identifies core alerts in the third earliest interval Interval_3 but does not assign the core alerts to a cluster. FIG. 30 shows an example of core alerts identified in the third earliest interval Interval_3. Each of the alerts is shown with a corresponding alert ID. Neighborhoods of the core alerts A₂₀, A₂₁, and A₂₂ contain 3 core alerts. The alerts A₂₀, A₂₁, and A₂₂ are labeled as core alerts in column 2507. Note that the core alerts are not assigned a cluster ID. Identification of core points in Interval_3 completes border alert detection in Interval_2 because there may be border alerts in Interval_2 that are close to core alerts in Interval_3.

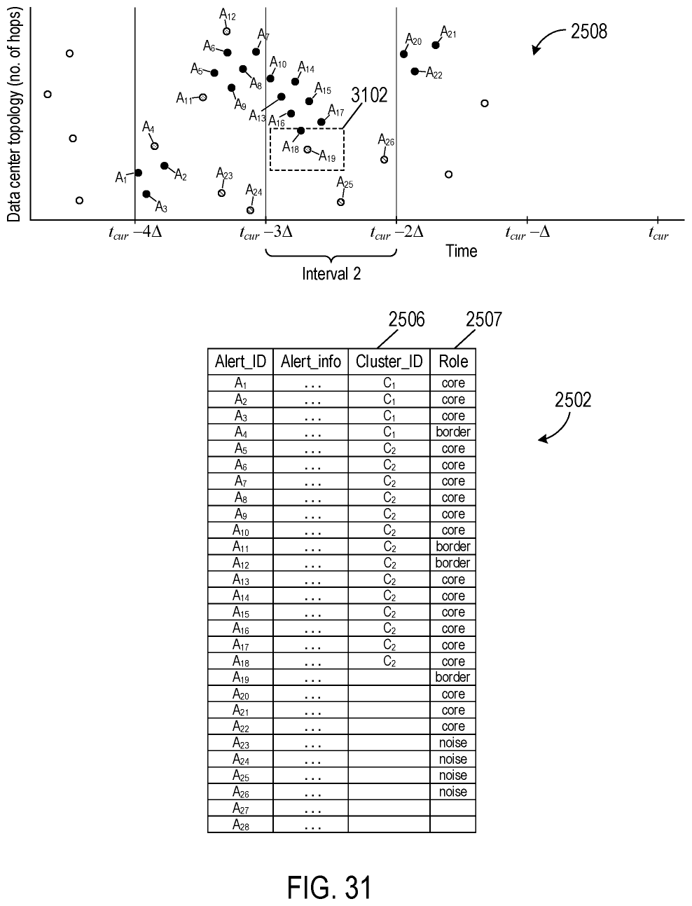

The analytics engine 1508 identifies border alerts and noise in the second earliest interval Interval_2. FIG. 31 shows a neighborhood 3102 of alert A₁₉. The neighborhood 3102 contains a total of 2 alerts, one of which is core alert A₁₈. The alert A₁₉ is identified as a border alert and labeled as a border alert in column 2507 of the data table 2502. In FIG. 31, neighborhoods of the alerts A₂₅ and A₂₆ do not contain additional alerts. As a result, the alerts A₂₅ and A₂₆ are identified as noise. The alerts A₂₅ and A₂₅ are labeled as noise in column 2507.

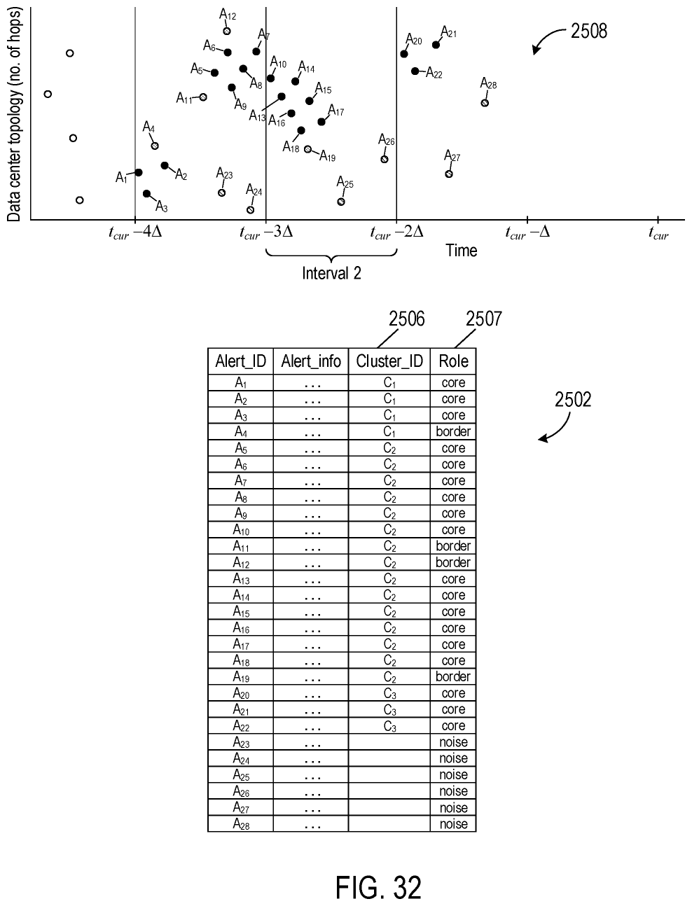

The analytics engine 1508 identifies border alerts and noise in the second earliest interval Interval_3. In FIG. 32, neighborhoods of the alerts A₂₇ and A₂₈ do not contain additional alerts. As a result, the alerts A₂₇ and A₂₈ are identified as noise. The alerts A₂₇ and A₂₈ are labeled as noise in column 2507. The neighborhoods of the alerts A₂₇ and A₂₈ do not include the alerts in the core alerts A₂₀, A₂₁, and A₂₂. As a result, the core alerts A₂₀, A₂₁, and A₂₂ belong to the same cluster and are labeled with the same cluster ID C₃ in column 2506.

In another implementation, the analytics engine 1508 executes time evolution clustering of alerts and coverage evolution of alerts as batch processes. These batch processes are performed on historical alerts recorded in the alerts database 1513 and on alerts up to the current time t_{cur}.

The analytics engine 1508 performs time evolution clustering by sorting the alerts recorded in a historical time period from earliest to latest. The analytics engine 1508 identifies a first alert A(t₁) as first alert member and detects other alerts that should be grouped with the alert A(t₁) to grow the cluster. Starting from the next earliest alert A(t₂), if the alert A(t₂) is in time and topology proximity with each of the alerts, the alert A(t₂) is added to the cluster.

Consider the example seven alerts list in table 1902 stored in the alerts database 1513 of FIG. 19. The analytics engine 1508 sorts the seven alerts based on time from the earliest to the most recent.

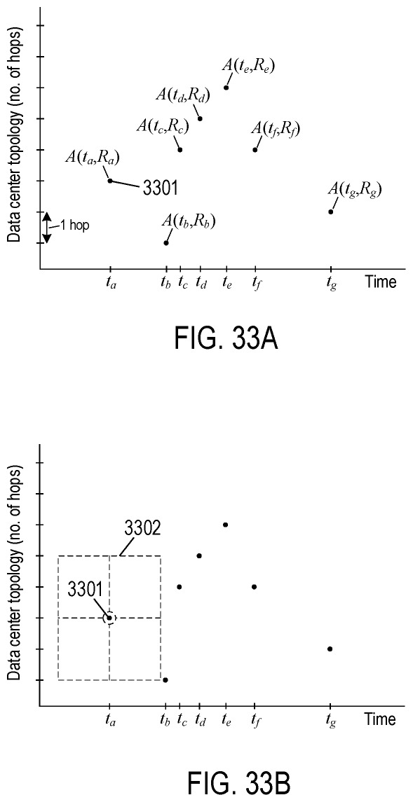

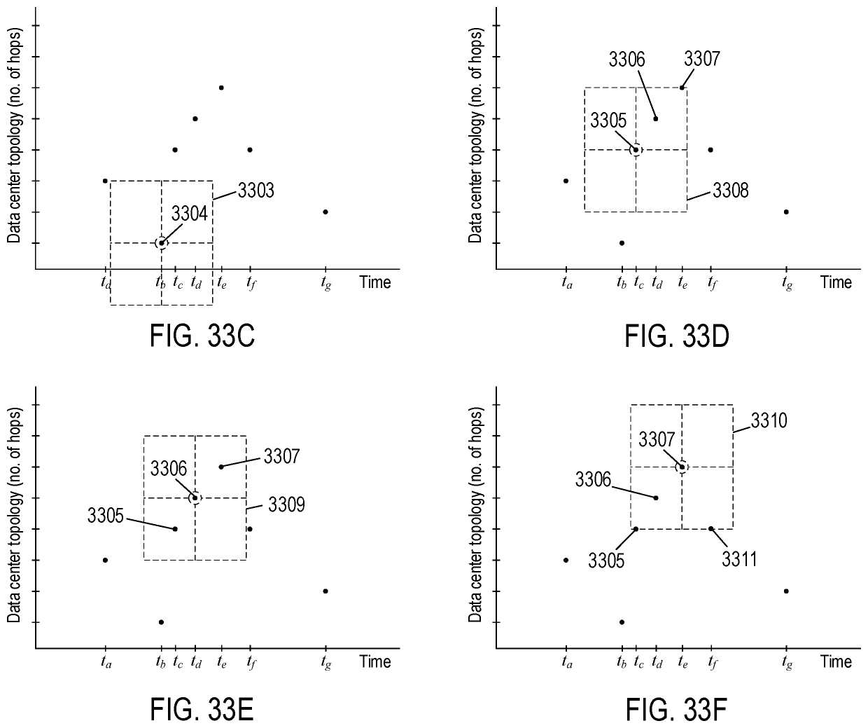

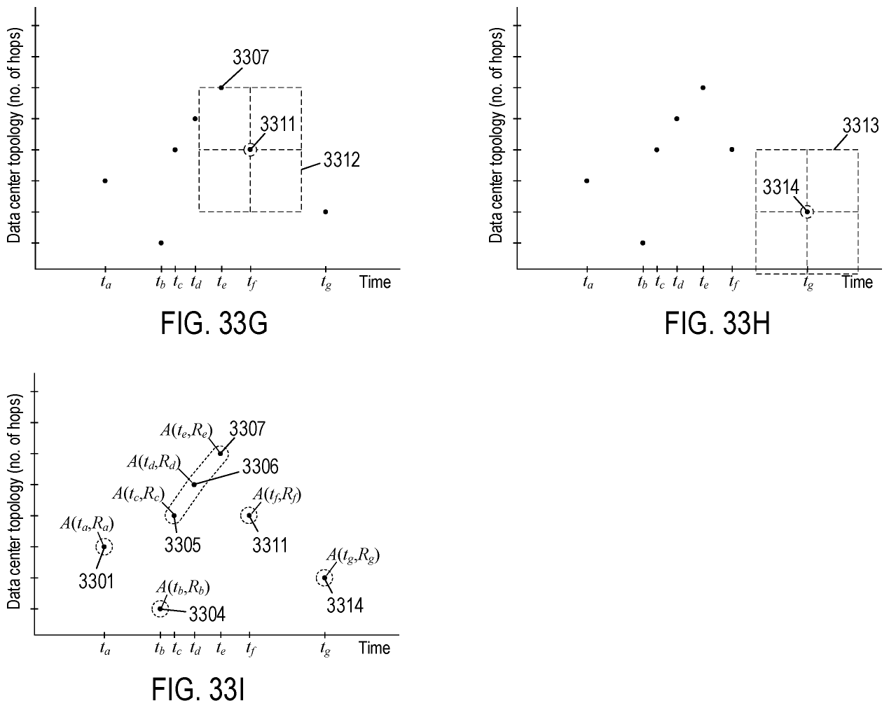

FIGS. 33A-33I show an example of using time evolution to grow a cluster of alerts. FIG. 33A shows a plot of seven alerts. The analytics engine 1508 identifies the earliest alert. A(tₐ, Rₐ), 3301 and tries to grow a cluster by determining whether neighborhoods of each of the other alerts lie within a neighborhood of the alert A(tₐ, Rₐ). In FIG. 33B, a neighborhood 3302 centered at the alert 3301 does not include other alerts. As a result, the alert 3301 is identified as an isolated incident. In FIG. 33C, a neighborhood 3303 centered at the alert 3304 does not include other alerts. As a result, the alert 3304 is identified as an isolated incident. FIGS. 33D-33F illustrate growing a cluster from the alert 3305 to include the alerts 3306 and 3307. In FIG. 33D, a neighborhood 3308 centered at the alert 3305 encompasses the alerts 3306 and 3307. In FIG. 33E, a neighborhood 3309 centered at the alert 3306 encompasses the alerts 3305 and 3307. As a result, the cluster has grown from alert 3305 to include the alert 3306. In FIG. 33F, a neighborhood 3310 centered at the alert 3307 encompasses the alerts 3305 and 3306. As a result, the cluster has grown from alerts 3305 and 3306 to include the alert 3307. Note that the neighborhood 3216 also includes an alert 3311. However, as shown in FIG. 33G, a neighborhood 3312 centered on alert 3311 only contains the alert 3307 and does not contain the other two alerts 3305 and 3306. As a result, the incident is not expanded to include the alert 3311. In FIG. 32H, a neighborhood 3313 centered at the alert 3314 does not include other alerts. As a result, the alert 3314 is identified as an isolated incident. FIG. 331 shows the four incidents identified in FIGS. 33A-33H. Four incidents 3301, 3304, 3311, and 3314 are isolated alerts and are identified as noise. The resulting cluster contains the three alerts 3305-3307.

In another implementation, the analytics engine 1508 performs coverage evolution by determining the local density degree of alerts in the neighborhood associated with each alert. The density degree is a count of the number of alerts contained within the neighborhood centered at an alert. The alert having the largest density degree is identified. In case of more than one alert having that same density degree, the neighborhood associated with the earlier time is identified. The alerts within the neighborhood with the largest density degree are identified as a cluster and assigned a cluster ID. Alerts with the second largest density degree are identified as a cluster and assigned a different cluster ID. Note that alerts common to the first and second clusters are assigned to the first cluster. In other words, the second cluster is composed of the remaining alerts that have not been assigned to the first cluster.

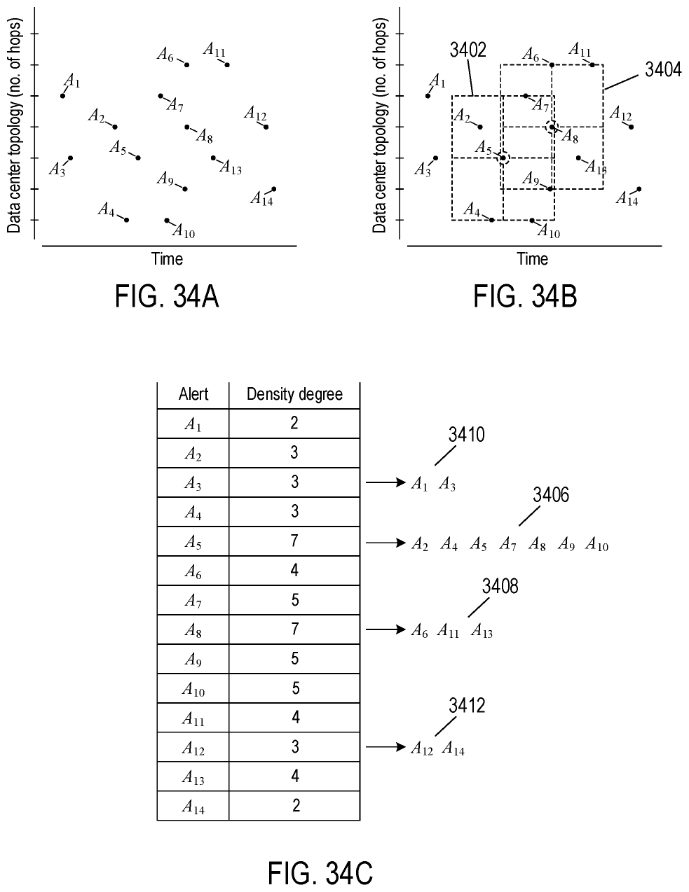

FIGS. 34A-34C show an example of using coverage evolution to identify a cluster of alerts. FIG. 34A shows an example of 14 alerts occurring in a historical time period. For each alert, the analytics engine 1508 identifies and count the alerts in the neighborhood of the alert. FIG. 34B shows a neighborhood 3402 centered on alert A₅. In this example, the neighborhood 3402 contains 7 alerts: A₂, A₄, A₅, A₇, A₈, A₉, and A₁₀. As a result, the alert A₅ has a density degree of 7. The neighborhood 3404 centered on alert A₈ contains 7 alerts: A₅, A₆, A₇, A₈, A₉, A₁₁, and A₁₃. As a result, the alert A₈ has a density degree of 7. FIG. 34C shows a table of density degrees for the alerts shown in FIG. 34A. Alerts A₅ and A₈ have the same largest density degrees of 7. In this example, the alert A₅ has an earlier start time than the alert A₈. A first cluster 3406 C₁ is formed from the alerts located within the neighborhood 3402. A second cluster 3408 C₂ is formed from the alerts in the neighborhood 3404, excluding the alerts that are located within the first cluster C₁. Cluster C₃ 3410 and cluster C₄ 3412 are formed from the remaining alerts in neighborhoods of the alerts A₁ and A₁₂.

The processes described above for detecting clusters of alerts do not distinguish alerts in a cluster of alerts that correspond to related event types. Consider, for example, a cluster of alerts in which the alerts have related event types. Also, consider two alerts in which a second alert occurs after a first alert and the first alert lies within the neighborhood centered on the second alert. Because the first alert lies within the neighborhood of the second alert, the processes described above identify the second alert as being part of the cluster that contains the first alert. In other words, the second alert is close enough in time and topological proximity to be identified as belonging to the cluster associated with the first alert. However, the second alert may have been triggered by an event that is not related to the event types that triggered the alerts of the cluster.

User feedback provides a meaningful assessment of which alerts that are part of a cluster of alerts have related event types. One approach to taking into consideration user feedback is to allow clusters to mature before user feedback is used to detect which alerts in the cluster correspond to the same incident. However, waiting for a cluster of alerts to mature is a slow incorporation of user feedback. Alternatively, processes described below provide a flexible update mechanism for runtime alerts by enabling users to provide feedback as alerts are triggered at runtime of the objects of the data center and utilize the user feedback to assess subsequent runtime alerts for addition to evolving incidents in clusters of alerts.

Processes for detecting incidents as described below provide the following advantages:

1. Detection of small data center issues represented by a relatively small set of clusters with interrelated alerts.

2. Track dynamic evolution of incidents over time, as described above with FIGS. 20A-20F.

3. Identify noise, or standalone, alerts that are excluded from clusters of alerts and correspond to isolated incidents.

4. Discover incidents within the clusters of alerts that are stored in the alerts database 1513 and are used for troubleshooting and executing remedial measures to correct runtime incidents.

Processes described below include generating a GUI that enables users, such as systems administrators and data center tenants, to provide feedback as alerts are triggered at runtime so that each alert that is a candidate for addition to an incident can be evaluated based on the event type of the alert and the event types of alerts in the cluster. The GUI enables a user to tune proximity parameters and refine conditions for declaring core alerts (i.e., adjust parameters of the neighborhood). The GUI enables user feedback in viewing underlying event types in clusters of streaming alerts, since the processes rely on core alerts that form clusters and enlarges clusters through other core alerts and reliably identifies core alerts. In other words, user feedback can be used to determine which neighboring alerts within a cluster of alerts belong to the same incident based on the context of the event types associated with the alerts. In particular, user feedback enables users to 1) suggest core alerts with the ability for users to designate each alert considered for addition to an incident as “not indicative,” “indicative,” and a “root cause” of the problem that created the incident; 2) use this data to refine parameters of core alert conditions; 3) exclude runtime alerts that occur within neighborhoods of alerts defining the incident if the event types of the alerts have previously been identified as “not indicative”; and 4) use root cause validations in recommending and executing remedial action. Current management tools executing in data centers do not incorporate user feedback in assessing alerts that are part of the same incidents in data centers and in determining appropriate remedial measures to correct the problems that created the incidents.

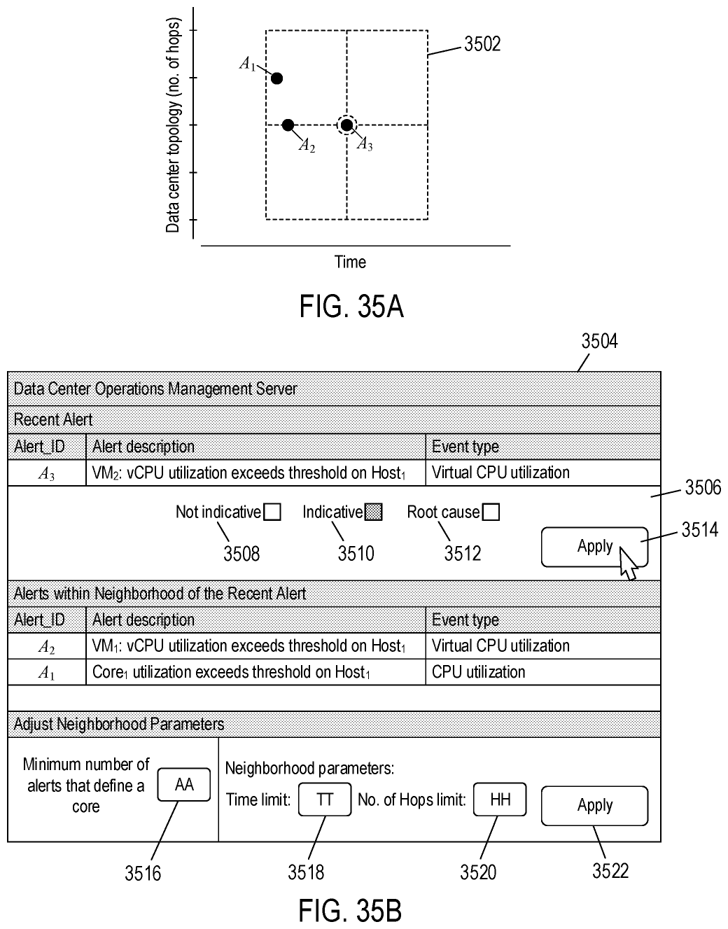

FIG. 35A shows an example of three alerts identified as A₁, A₂, and A₃. The alerts A₁ and A₂ lie within the neighborhood 3502 of the alert A₃. If the MinPts=3, then the alert A₃ is identified as a core alert and added to a cluster of alerts comprising A₁, A₂, and A₃. FIG. 35B shows an example GUI 3504 with a pane 3506 that enables a user to identify the runtime alert A₃ as “not indicative” 3508, “indicative” 3510, or a “root cause” 3512 of the events that underlie the cluster of alerts A₁ and A₂. The GUI 3504 displays the alert IDs, alert descriptions, and event types of the preceding alerts A₁ and A₂. The GUI 3504 displays the alert ID, alert description, and event type of the runtime alert A₃. A user can view that preceding alerts A₁ and A₂ and the runtime alert A₃ correspond to CPU utilization of the host Host₁ and have similar event types. In this example, the user designates the runtime alert A₃ as “indicative” of an underlying problem that created the events that, in turn, trigger the alerts A₁ and A₂. Clicking on button 3514 designates the alert A₃ as “indicative” and adds the alert A₃ to an incident data file that records information about the alerts A₁, A₂, and A₃, such as the alert ID, alert description, and the assigned designation. The incident data file is stored in incidents database 1515.

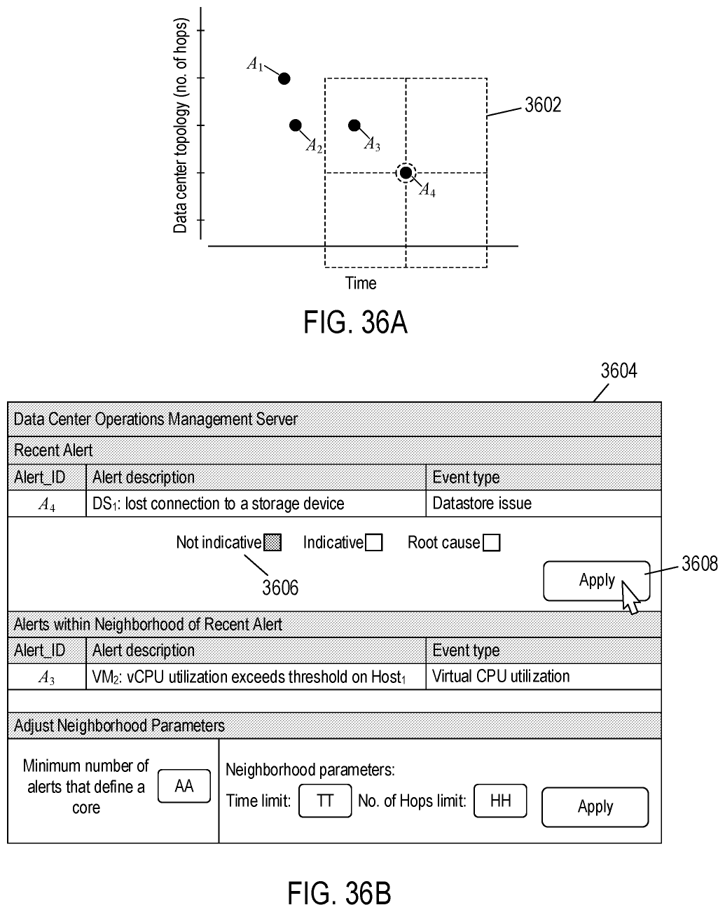

FIG. 36A shows an example of a runtime alert A₄ with a neighborhood 3602 that encompasses preceding alert A₃. The runtime alert A₄ is identified as a border alert of the cluster of alerts A₁, A₂, and A₃. FIG. 36B shows GUI 3604 with the description and event type of the runtime alert A₄ and the description and event type of the preceding alert A₃. A user can view that the preceding alert A₃ corresponds to virtual CPU usage event type and the runtime alert A₄ corresponds to a datastore event type. In this example, the user designates the runtime alert A₄ as “not indicative” of an underlying problem that created the events associated with the alerts A₁, A₂, and A₃. Clicking on button 3608 designates the alert A₄ as “not indicative” and the alert A₄ is not added to (i.e., excluded from) the incident data file.

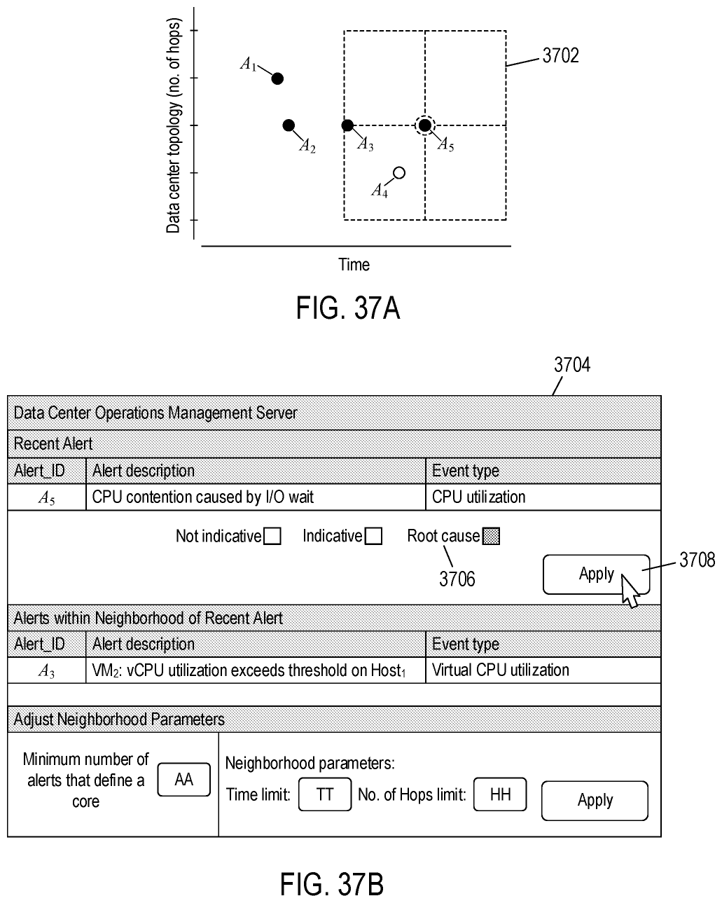

FIG. 37A shows an example of a runtime alert A₅ with a neighborhood 3702 that encompasses preceding alert A₃. The runtime alert A₅ is identified as a border alert of the cluster of alerts A₁, A₂, and A₃. Note that preceding alert A₅ is identified as noise and is excluded from the cluster of alerts A₁, A₂, and A₃. FIG. 37B shows GUI 3704 with the description and event type of the runtime alert A₅ and the description and event type of the preceding alert A₃. A user can view that the preceding alert A₃ corresponds to virtual CPU usage event type and the runtime alert A₅ corresponds to a CPU utilization event type. The alert description reveals that the runtime alert A₅ is the result of CPU contention caused by I/O wait. In this example, the user designates the runtime alert A₅ as a “root cause” of the underlying problem that created the events associated with the alerts A₁, A₂, and A₃. Clicking on button 3708 designates the alert A₅ as the “root cause” and the alert A₅ is added to incident data file.

Note that each of the GUIs 3504, 3604, and 3704 includes a pane that enables a user to adjust the neighborhood parameters. For example, returning to FIG. 35B, GUI 3504 enables a user to reset the minimum number of alerts (i.e., MinPts) that define a core alert in field 3516, change the time limit (i.e., T_{ε}) in field 3518, and change the number of hops limit (i.e., K_{ε}) in field 3520. Once the parameters are entered into the fields 3516-3518, the user clicks on button 3520 to implement changes as to how future alerts are classified as core, border, and noise going forward.

In one implementation, when a user identifies alerts with a pair of event types occurring in the same neighborhood as “not indicative,” as described above with reference to FIG. 36B, the pair of event types are stored in a not indicative event types database. The not indicative event types database is used to evaluate pairs of event types of subsequent runtime alerts that occur in the same neighborhood. When a runtime alert is triggered and the neighborhood of the alert contains a previous alert and the corresponding event type pair match an event type pair in the not indicative event type database, the runtime alert is automatically designated as not indicative. On the other hand, if the event type pair does not match any of event type pairs in the not indicative event type database, a GUI is displayed on a display screen and the user is prompted to designate the runtime alert “not indicative,” “indicative,” or “root cause,” as described above with reference to FIGS. 35A-37B.

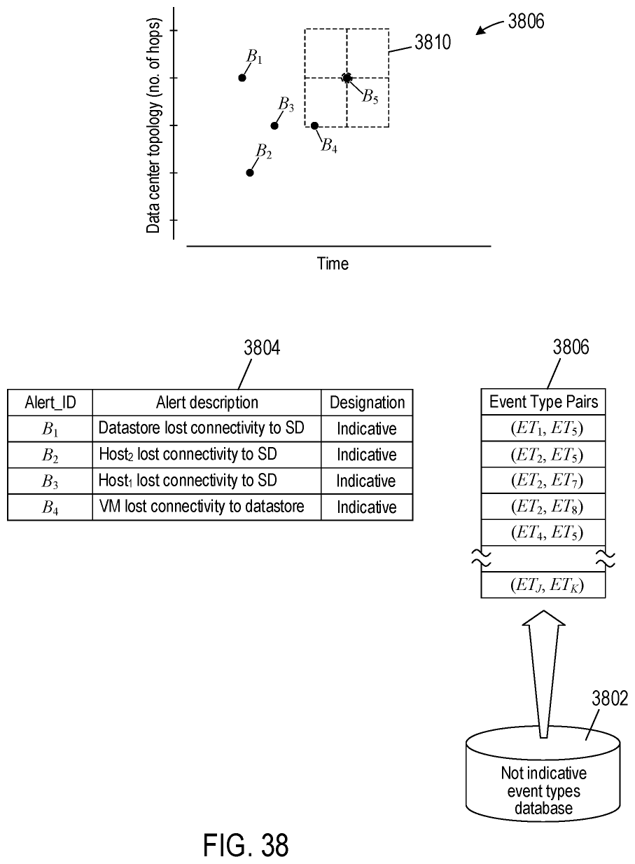

FIG. 38 shows an example of using a not indicative event types database 3802 created by a user to detect runtime not indicative alerts. In FIG. 38, an incident data file 3804 records the alerts B₁, B₂, B₃, and B₄ displayed in plot 3806, alert descriptions, alert designations, and other information regarding the alerts (not shown for the sake of illustration). In this example, the alerts B₁, B₂, B₃, and B₄ have already been identified as corresponding to event types associated with the same incident. FIG. 38 also shows table 3806 that records pairs of event types designated as not indicative by a user via the GUI describe above with reference to FIGS. 35A-37B. A runtime alert B₅ is triggered and a neighborhood 3810 centered at the alert B₅ contains preceding alert B₄. Suppose the event type of the alert B₅ is ET₅ and the event type for the alert B₄ is ET₄. In table 3806, the event type pair (ET₄, ET₅) has been previously identified as “not indicative.” As a result, the alert B₅ is not added to the incident data file 3804. If the event type pair (ET₄, ET₅) had not already been included in the not indicative event types database 3802, the user is presented with a GUI described above with reference to FIGS. 35A-37B, enabling the user to designate the alert B₅.

In another implementation, the feedback of many users of various roles in the data center environment is collected to calculate a confidence score for pairs of event types that are excludable (i.e., “not indicative”) from time and topology proximity considerations. The confidence score for a pair of excludable event types denoted by ET; and ET; is calculated by

$${C}_{i , j} = {\sum }_{r = 1}^{R} {W}_{r} \times Indicativeness ( r , i , j ) \qquad ( 5 )$$

where
r is a user level of expertise index;
R is the number of levels of expertise;
Wᵣ is a weight associated with the r-th level of expertise; and
Indicativeness(r, i, j) is the fraction of user's at the r-th level of expertise that designated the pair of event types ETᵢ and ETⱼ as not indicative.

In certain data centers, the levels of expertise are administrator, read only, restricted with an administrator having the highest level of expertise, restricted having the lowest level of expertise, and read only having a middle level of expertise. In this case, the number of levels of expertise is three (i.e., R=3). In other data centers, the levels of expertise have different administrator levels, different read only levels, and different restricted access levels. The numerical value assigned to the weight, Wᵣ, is larger for users with more expertise and smaller for users with less expertise. Examples of weights that may be assigned to users with five different levels of expertise is given in the following table:

| Expertise of User | Weight (Wᵣ) |
|---|---|
| Administrator-level-1 | 1 |
| Administrator-level-2 | 0.8 |
| Read-only | 0.6 |
| Restricted-level-1 | 0.4 |
| Restricted-level-2 | 0.2 |

The indicativeness in the confidence score is given by

$$Indicativeness ( r , i , j ) = \frac{NI ( r , i , j )}{\vert r \vert}$$

where
   |r| is the number of users at the r-th user level of expertise (e.g., number of administrators or number of users with read only level of expertise); and
NI(r, i, j) is the number of users at the r-th level of expertise who designated the pair of event types ETᵢ and ETⱼ as not indicative.
   For example, NI(r, i, j) is the number of r-th level users who designated the pair of event types ETᵢ and ETⱼ as “not indicative,” such as the GUI 3604 described above with reference FIG. 36B.

The confidence score is compared with a user-defined confidence score threshold, Th_{ind}, to determine whether alerts associated with a pair of event types is indicative or not indicative. For example, the confidence score threshold Th_{ind} can be set to 0.50, 0.60, or 0.70. When C_{i,j}>Th_{ind}, the alerts of the pair of event types ETᵢ and ETⱼ are not indicative. By contrast, when C_{i,j}≤Th_{ind}, the alerts of the pair of event types ETᵢ and ETⱼ may be indicative or a root cause.

When a runtime alert is triggered and the neighborhood of the alert contains a previous alert and the corresponding pair of event types ETᵢ and ETⱼ matches a pair of event types in the not indicative event type database, the confidence score C_{i,j} of the pair of event types is compared to the threshold Th_{ind}. If C_{i,j}>Th_{ind}, the alert is designated as not indicative. On the other hand, if C_{i,j}≤Th_{ind}, the GUI described above is displayed and the user is prompted to designate the runtime alert as described above with reference to FIGS. 35A-37B. If the user identifies the pair of event types as “not indicative,” the confidence score is recalculated according to Equation (5) and the previous confidence score associated with pair of event types ET; and ET; is replaced with the new confidence score.

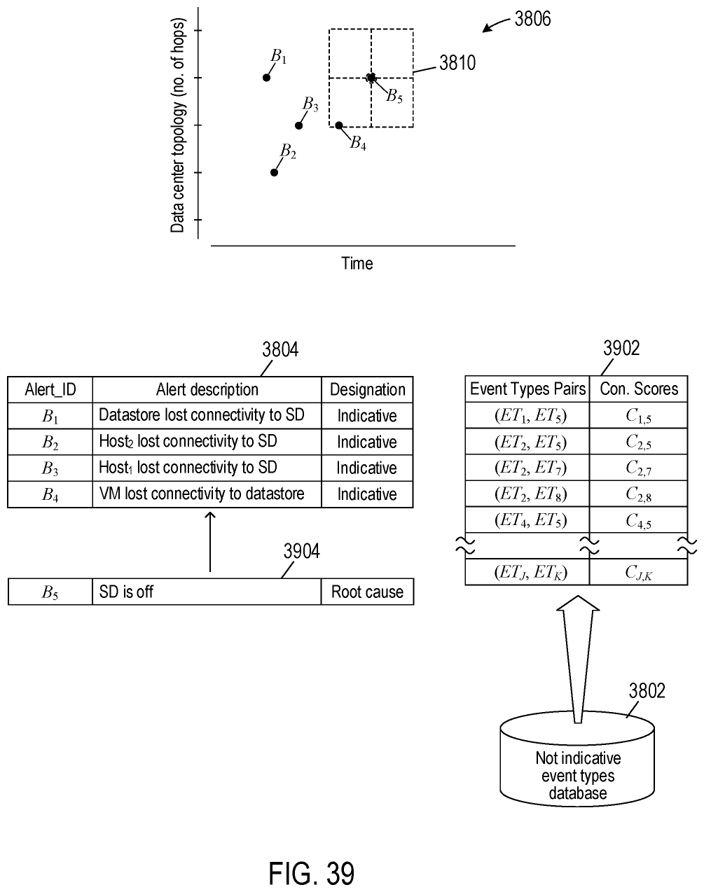

FIG. 39 shows an example of using a not indicative event types database 3902 created by multiple users to designate the alert described in FIG. 38. FIG. 39 shows the incident data file 3804 that records the alerts B₁, B₂, B₃, and B₄ displayed in plot 3806 as described above with reference to FIG. 38. FIG. 39 also shows table 3906 of pairs of event types designated as not indicative by multiple users via the GUI describe above. Table 3902 includes confidence scores associated with each pair of the event types. In this example, the runtime alert B₅ is triggered and the neighborhood 3810 centered at the alert B₅ contains preceding alert B₄. Suppose the event type of the alert B₅ is ET₅ and the event type for the alert B₄ is ET₄. In table 3902, the event type pair (ET₄, ET₅) has a confidence score C_{4,5}. If C_{4,5}>Th_{ind}, the alert B₅ is designated as not indicative. On the other hand, if C_{4,5}≤Th_{ind}, the GUI described above is displayed and the user is prompted to designate the runtime alert B₅ as described above with reference to FIGS. 35A-37B. In this example, the user designated the runtime alert B₅ as a root cause, and the runtime alert B₅, alert description, and alert designation 3904 is added to the incident data file 3804.

The resulting clusters of alerts that exclude irrelevant not indicative alerts based on user feedback are incidents that are composed of alerts with related event types. Each of the incidents is stored as a separate incident data file in incidents database 1515.

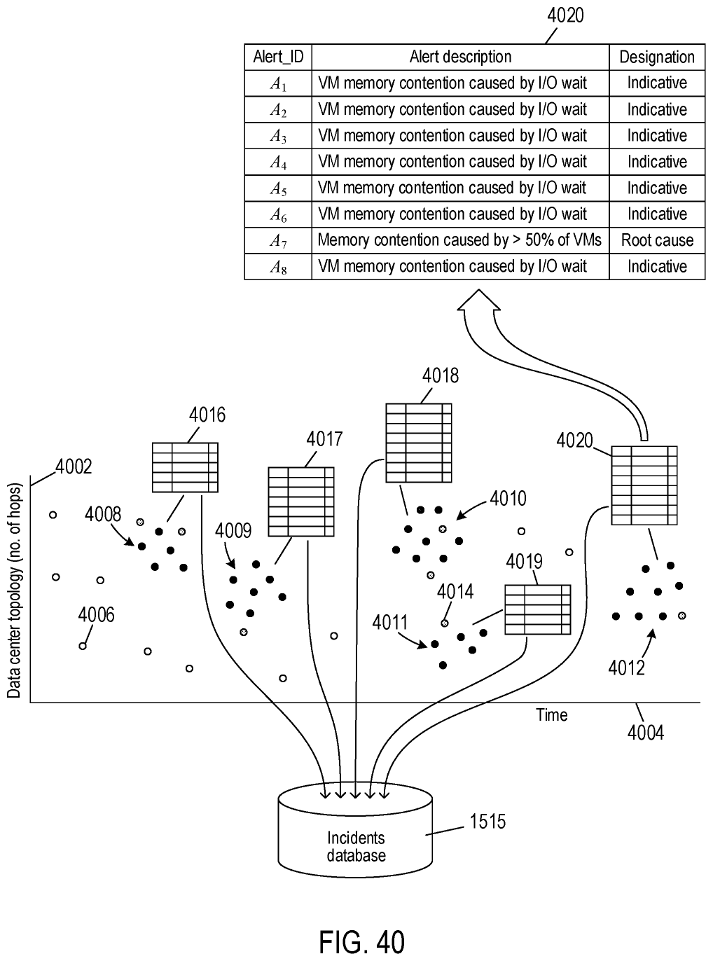

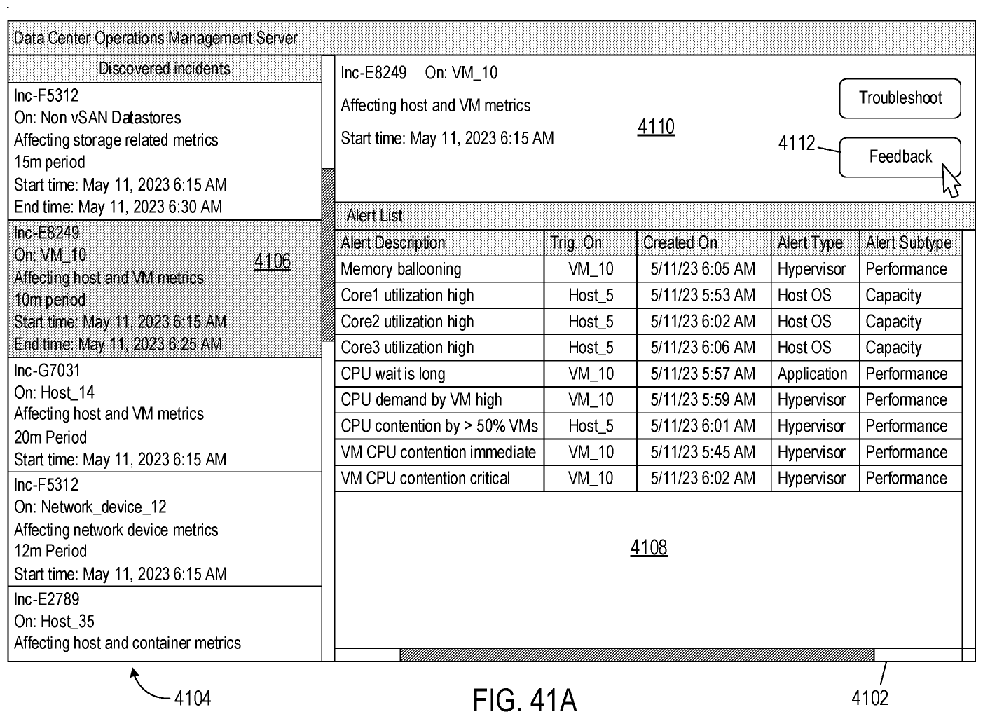

FIG. 40 shows an example plot of clusters of alerts that contain incidents. The horizontal axis 4002 represents time. The vertical axis 4004 represents the number of hops. Open points, such point 4006, represent noise alerts or single incidents. Clusters of black points 4008-4012 represent incidents composed of alerts with similar event types. Gray-shaded points represent alerts that occur in time and topological proximity with one or more alerts of the clusters 4008-4012 but have been identified by a user as being of an event type that does not correspond to the event types of the clusters 4008-4012. For example, cluster of alerts 4011 may represent VM alerts associated with VMs running on a host, such as alerts indicating the VMs are experiencing CPU contention. As each alert is discovered and displayed in a GUI, as described above, the user identifies the alerts as being “indicative” or a “root cause” based on the alert being CPU related event types. By contrast, alert 4014 may indicate a vSAN cluster object performance problem that is displayed in the GUI. However, in this case, the user identified the alert 4014 as “not indicative” of the event types of the alerts in the cluster 3811. In other words, although the alert 4014 lies within time and topological proximity of certain alerts in the cluster of alerts 4011, the alert 4014 is excluded by the user via the GUI, as described above, as being “not indicative” of the event types of the cluster of alerts 4011. Each of the clusters of alerts 4008-4012 with related event types correspond to separate incidents and are recorded in separate corresponding data files 4016-4020. For example, data file 4020 contains alert IDs, alert descriptions, and indicative or root cause designations for each of the alerts. In this example, the data file 4020 is enlarged to reveal memory contention problems for VMs running on a host. The VM memory contention problems have been identified as “indicative” and the memory contention caused by more than 50% of the VMs has been identified as a “root cause.” The incident data files 4016-4020 are stored in incidents database 1515.

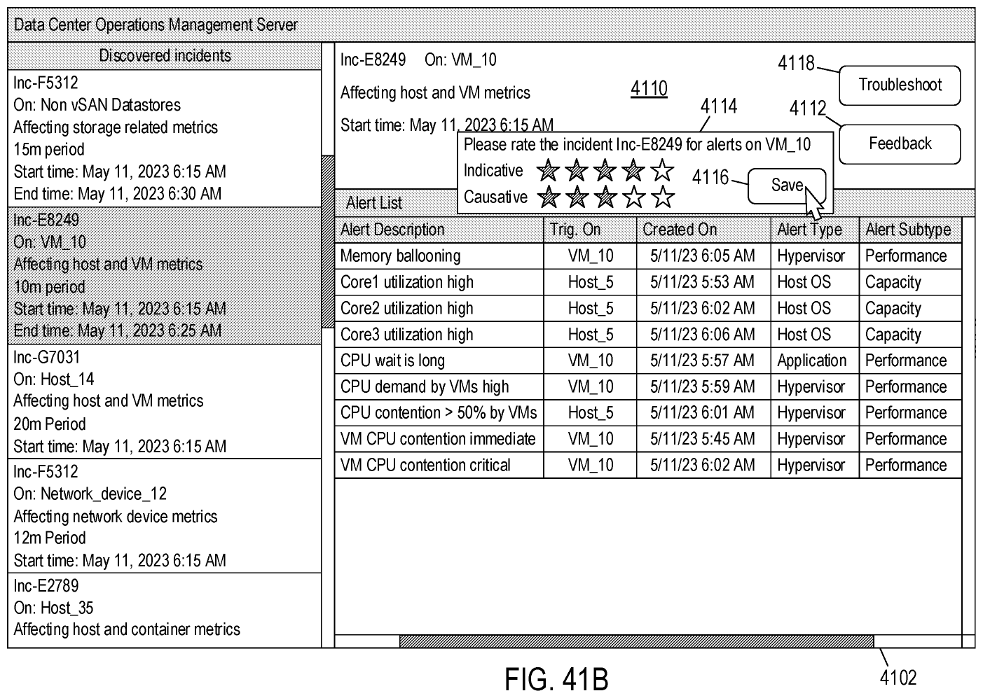

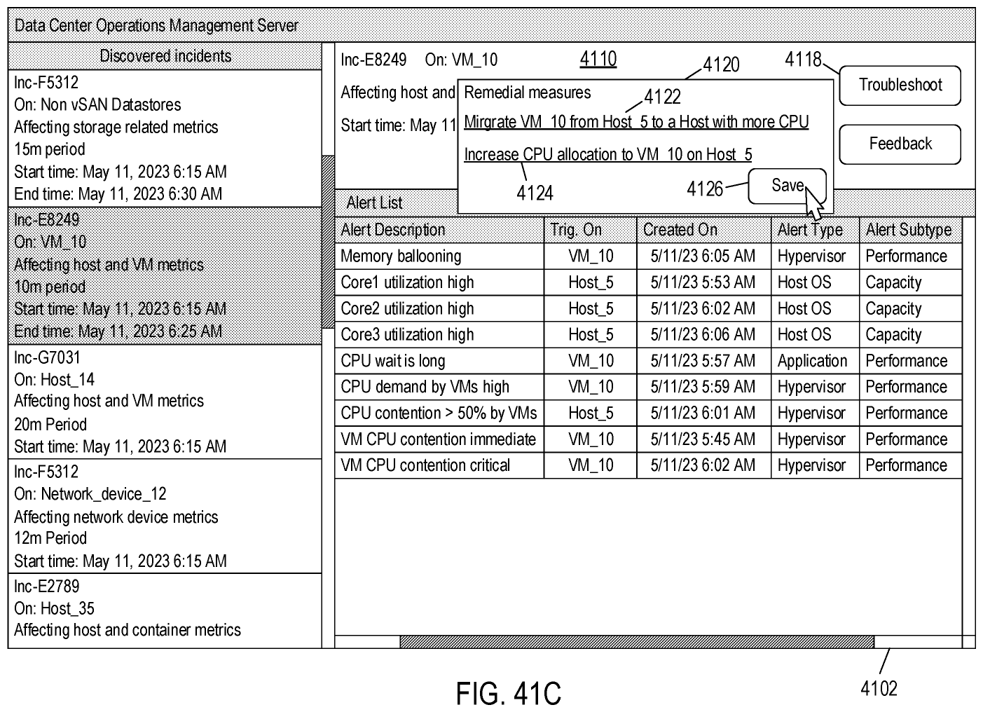

FIGS. 41A-41C show an example GUI 4102 that enables a user to view each of the discovered incidents and input feedback and troubleshoot the root cause of the incidents in the incidents database. The GUI 4102 displays pane 4104 that contains a list of discovered incidents. In this example, each incident appears in a separate panel of pane 4104 and is identified by an incident ID, the object on which the incident occurred, affected metrics, and range of time of the alerts comprising the incident. A user clicks on one of the panels in pane 4104 to reveal the alerts that comprise the incident in a separate pane of GUI 4102. For example, dark shading indicates a user has clicked on pane 4106, which displays a table of the alerts and detailed information about each of the alerts in pane 4108. The GUI 4102 includes pane 4110 that displays information about the incident in panel 4106. Pane 4110 includes a button 4112 that enables a user to input feedback. When a user clicks on the button 4112, a pop-up pane 4114 is displayed as shown in FIG. 41B. The pane 4114 enable a user to input an indicative score (e.g., from 0 to 5) of how representative the alerts are of the problem at VM_10 and input a causative score (e.g., from 0 to 5) of how representative the alerts of the root cause of the problem at VM_10. In this example, the user has input an indicative score of four for how representative the alerts are of the problem at the VM_10 and has input a causative score of three for how representative the root cause of the problem at the VM_10. The indicative score and the causative score of the incidents are recorded with the incident data file in the incidents database 1515 when the user clicks the save button 4116. Pane 4110 in the GUI 4102 includes a troubleshoot button 4118. When a user clicks on the troubleshoot button 4118 a pop-up pane 4120 is displayed as shown in FIG. 41C. In this example, the user has input links 4122 and 4124 to execute remedial measures to correct the root cause of the events that created the incident. The user saves remedial measures with the incident data file in the incident database 4024 by clicking on the save button 4126.

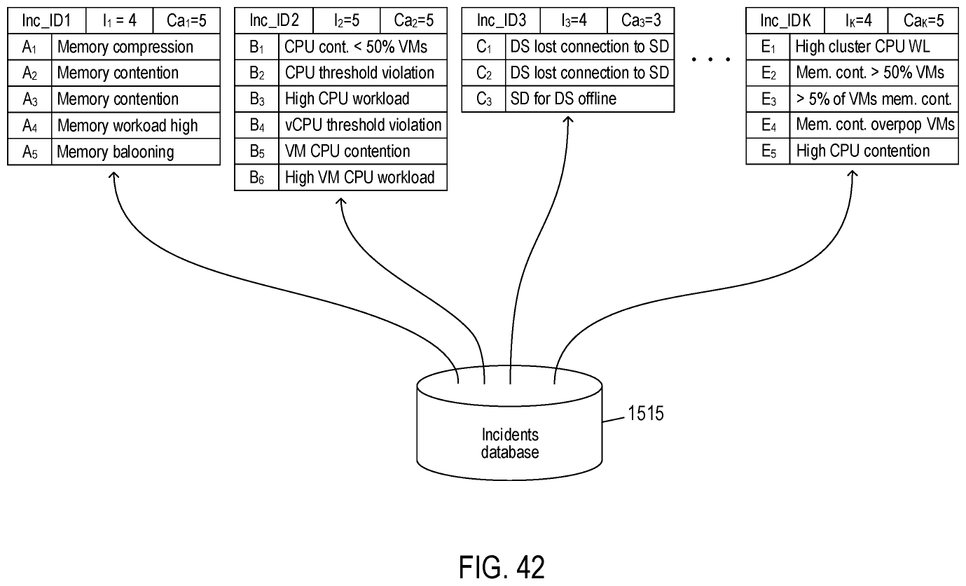

FIG. 42 shows an example portion of K incident data files of the incidents database 1515. Each incident data file includes an incident ID denoted by Inc_ID1-Inc_IDK, an indicative score denoted by I₁-I_{K}, and a causative score denoted by Ca₁-Ca_{K}. Each incident contains information about the indicative and/or root cause of alerts comprising the incident. For example, incident “Inc_ID1” is a recorded of memory alerts associated with a VM. The user provided an incident score of 4 (“I₁=4”) and a causative score of (“Ca₁=5”) as described above with reference to FIGS. 41A-41B.

When a runtime cluster of alerts is generated in the data center, a runtime incident datafile is formed from the runtime cluster of alerts as described above with reference to FIG. 38 or FIG. 39. In other words, the runtime incident is composed of indicative and/or root cause alerts and the not indicative alerts are excluded as described above with reference to FIG. 38 or FIG. 39. The operations management server 1332 computes a similarity score between the runtime incident and each of the incident data files stored in the incidents database 4024. The similarity score is given by

$$J ( Inc\_IDr , Inc\_IDn ) = \frac{\vert Inc\_IDr ⋂ Inc\_IDn \vert}{\vert Inc\_IDr \vert + \vert Inc\_IDn \vert - \vert Inc\_IDr ⋂ Inc\_IDn \vert} \qquad ( 6 )$$

where
Inc_IDr represents a runtime incident with not indicative alerts excluded;
Inc_IDn represents the n-th incident data file of the incident database;
   |Inc_IDr| is the number of alerts in the runtime incident;
   |Inc_IDn| is the number of alerts in the n-th incident data file;
   |Inc_IDr∩Inc_IDn| is the number of alerts the runtime incident and the n-th incident data file have in common.
   When the similarity score satisfies the following condition:

$$J ( Inc\_IDr , Inc\_IDn ) > {Th}_{sim} \qquad ( 7 )$$

where Thₛᵢₘ is a similarity threshold (e.g., 0.55, 0.60, and 0.65), the corresponding incident of the incidents database 1515 are displayed in a GUI along with recommendations for executing remedial measures that were previously used to correct problems that created the incidents.

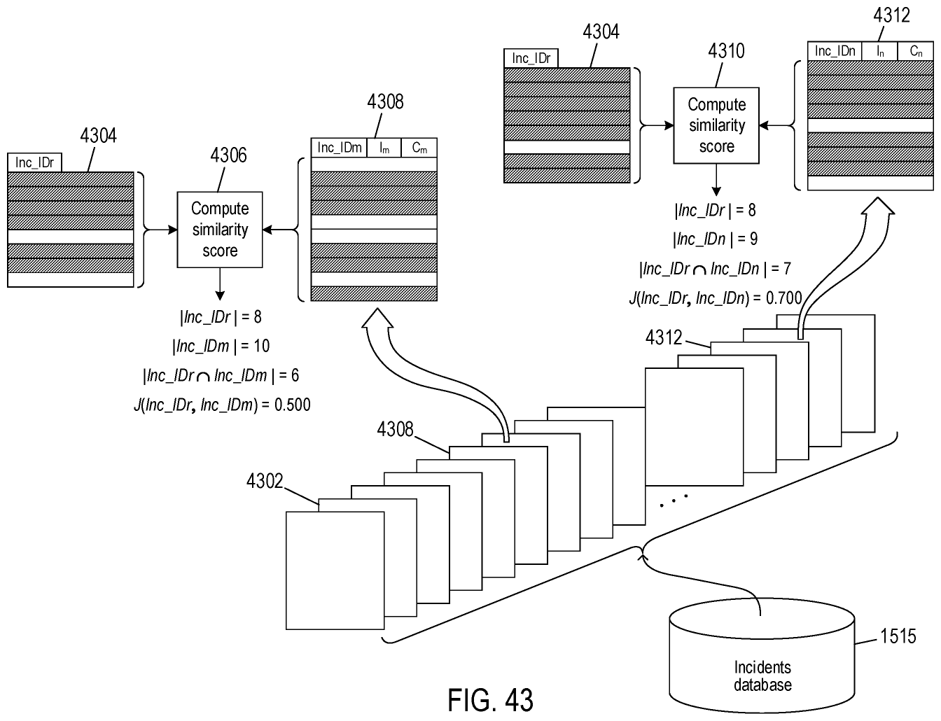

FIG. 43 shows examples of computing similarity scores for two incidents recorded in the incidents database. Rectangles, such as rectangle 4302, represent incident data files created for previously occurring incidents recorded in the incidents database 1515. Each incident data file is created as described above with reference to FIG. 38 or FIG. 39. A similarity score is computed between a runtime incident 4304 and each of the incident data files in the incident database 4024. Block 4306 represents computing a similarity score between the runtime incident 4306 and incident data file 4308 recorded in the incident database 4024. Rectangles of the runtime incident 4304 and the incident data file 4308 represent the indicative and/or root cause alerts recorded in the runtime incident 4304 and incident data file 4308. Dark shaded rectangles represent alerts that are common to the runtime incident 4304 and incident data file 4308. In this example, the runtime incident 4304 and incident data file 4308 have a similarity score of 0.500. Block 4310 represents computing a similarity score between the runtime incident 4304 and the incident data file 4312 recorded in the incident database 1515. In this example, the runtime incident 4304 and incident data file 4312 have a similarity score of 0.700, which is greater than a similarity threshold of 0.65. The incident ID, Inc_IDn, indicative score, Iₙ, and causative score, Cₙ, for the incident data file 4312 are displayed in a GUI with the corresponding recommendation for correcting the problem associated with the incident 4312.

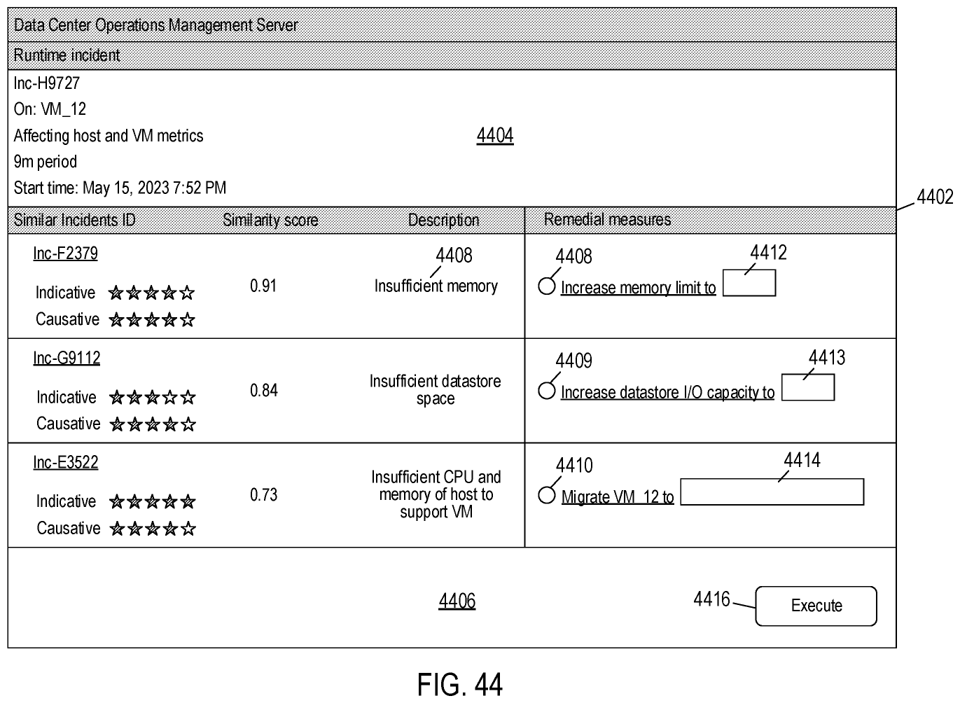

FIG. 44 shows a GUI 4402 that displays information about a runtime incident and previous incidents with similarity scores that are greater than the similarity threshold. The GUI 4402 includes a pane 4404 that displays information about the current runtime incident occurring on a VM executing in the data center. Pane 4406 displays incident IDs of three incident data files with similarity scores that are greater than the similarity threshold (e.g., Thₛᵢₘ=0.65). Each incident is displayed in pane 4406 with an incident ID, the indicative score and the causative score assigned by a user as described above with reference FIGS. 41A-41B, the similarity score computed according to Equation (6), and a description of the incident. Pane 4406 also displays the recommended remedial measures previously used to correct each of the three incidents. For example, the user clicks on one of the buttons 4408-4410 enters a value into one of the fields 4412 and 4413 or enters the address of a host to migrate the VM to in field 4414. The user then clicks on the execute button 4416 to launch execution of the selected remedial measure is executed to correct the problem that created the runtime incident.

Note that there is often more than one remedial measure that can be used to correct a problem that creates an incident in a data center. For example, in FIG. 44, three possible remedial measures may be executed to correct the problem occurring with VM_12. The selection of the remedial measures is determined by the user and is executed by the operations management server 1332 via the GUI 4402. Other examples of remedial measures that may be selected via a GUI and executed by the operations management server 1332 include migrating VMs from hosts limited resources, such as CPU, memory, and data storage, to hosts that can provide more resources. VMs may also be migrated when the contention time for host resources the VM is executing on is greater than a contention threshold. VM processing issues may also be resolved by increasing CPU usage, memory, and data storage to the VMs (i.e., increasing one or more resources), provides the increases are available on the host. Datastore problems can be remedied by assigning more data storage to the datastore or migrating the datastore to a host that has a larger volume of data storage. For example, clicking on the execute button 4416 in FIG. 44 launches a program, such as VMware's vMotion®, that migrates a VM, container, a datastore, or other object running on a host within seconds to a different host having more resources, such as CPU, memory, or data storage, in the data center.

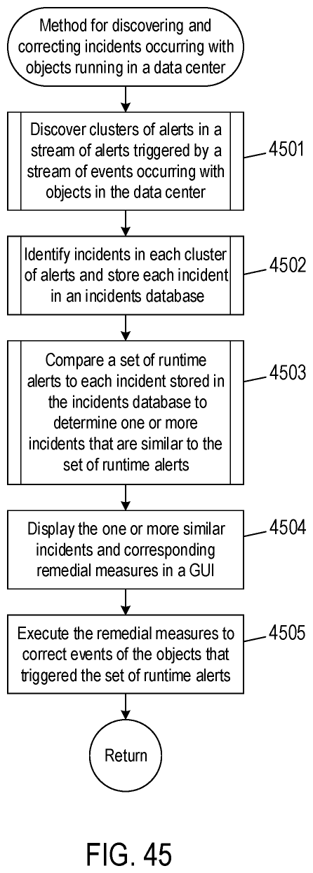

The methods described below with reference to FIGS. 45-51 are stored in one or more data-storage devices as machine-readable instructions and are executed by one or more processors of a computer system, such as the computer system shown in FIG. 1. The computer-implemented methods described below have the advantage of eliminating human errors in detecting performance problems with objects and resolving performance problems with objects in a data center. The computer-implemented methods also significantly reduce the time for detecting performance problems and identifying the root causes from days and weeks to minutes and seconds, thereby providing immediate notification of a problem behind a cluster of events, providing at least one recommendation for correcting the problem, and enabling the rapid launch and execution of one or more remedial measures that correct the problem.

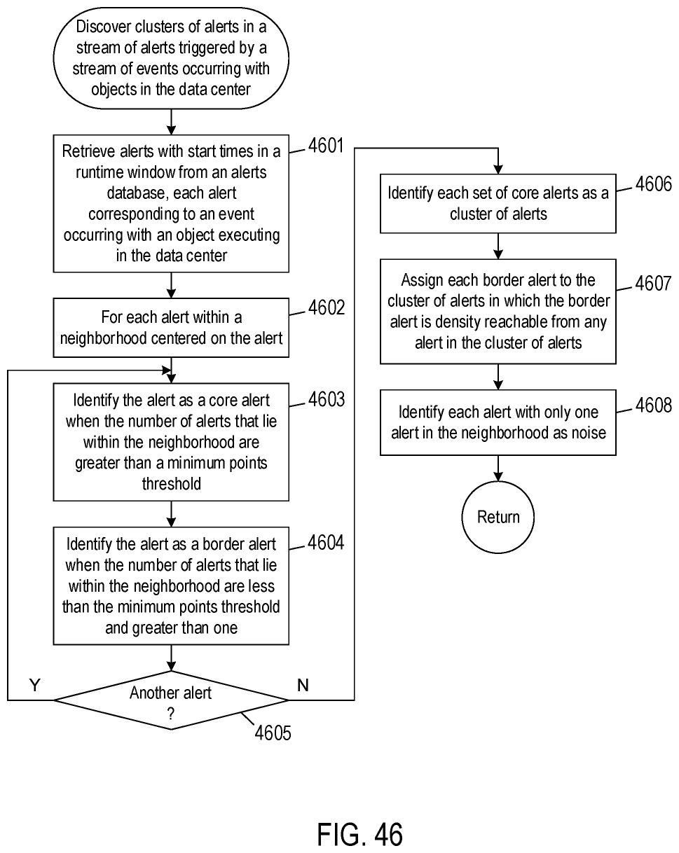

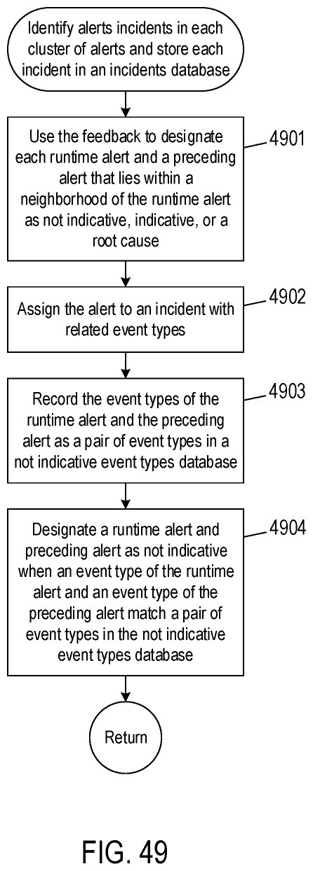

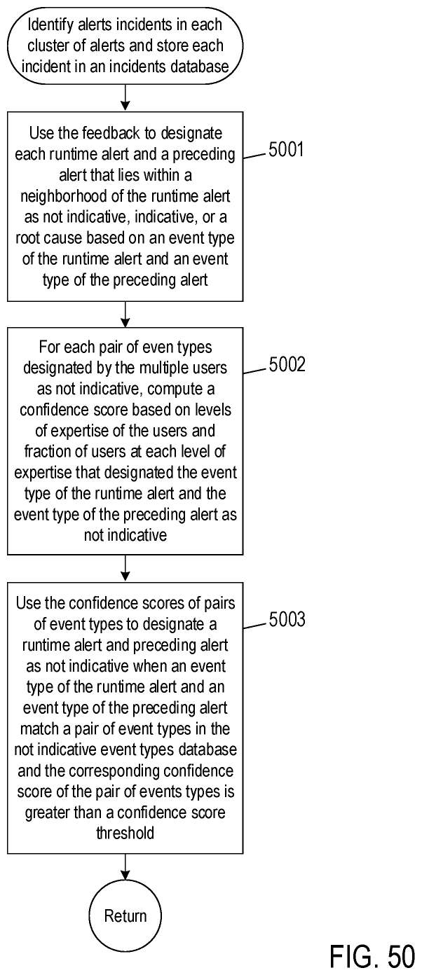

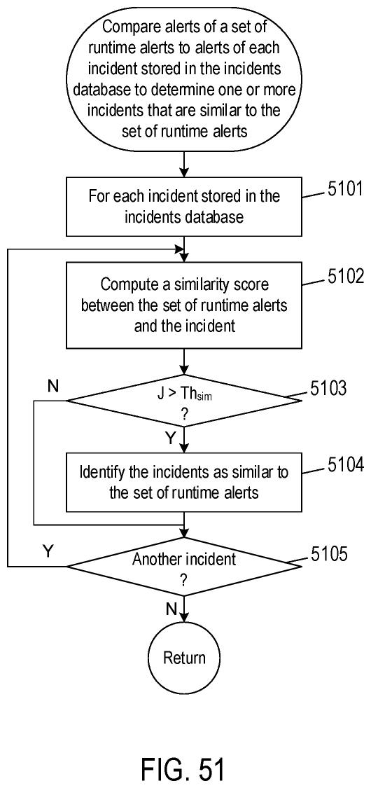

FIG. 45 is a flow diagram of a method for discovering and correcting incidents occurring with objects running in a data center. In block 4501, a “discover clusters of alerts in a stream of alerts triggered by a stream of events occurring with objects in the data center” procedure is performed. Example implementations of the “discovers clusters of alerts in a stream of alerts triggered by a stream of events occurring with objects in the data center” procedure is described below with reference to FIGS. 46-48. In block 4502, an “identify incidents in each cluster of alerts and store each incident in an incidents database” procedure is described below with reference to FIGS. 49 and 50. Example implementations of the “identify incidents in each cluster of alerts and store each incident in an incidents database” procedure is described below with reference to FIGS. 49 and 50. In block 4503, in response to the user identifying alerts in each cluster of alerts that correspond to separate incidents, comparing a set of runtime alerts to each incident stored in the incidents database to determine one or more incidents that are similar to the set of runtime alerts. In block 4504, a “compare a set of runtime alerts to each incident stored in the incidents database to determine one or more incidents that are similar to the set of runtime alert” procedure is performed. An example implementation of the “compare a set of runtime alerts to each incident stored in the incidents database to determine one or more incidents that are similar to the set of runtime alert” procedure is described below with reference to FIG. 51. In block 4505, the one or more similar incidents and corresponding remedial measures are displayed in graphic user interface (“GUI”) on a display screen as described above with reference to FIG. 44. In block 4506, a user selects one of the remedial measures displayed in the GUI and uses the GUI to launch execution of the selected measures to correct events of the objects that triggered the set of runtime alerts via the GUI.

FIG. 46 is a flow diagram of the “discover clusters of alerts in a stream of alerts triggered by a stream of events occurring with objects in the data center” procedure performed in block 4501 of FIG. 45. In block 4601, alerts with start times in a runtime window are retrieved from an alerts database, each alert corresponding to an event occurring with an object executing in the data center. A loop beginning with block 4602 repeats the operations represented by blocks 4603 and 4604 for each alert within a neighborhood centered on the alert. In block 4603, the alert is identified as a core alert when the number of alerts that lie within a neighborhood are greater than a minimum points threshold. In block 4604, the alert is identified as a border alert when the number of alerts that lie within the neighborhood are less than the minimum points threshold and greater than one. In block 4605, the operations represented by blocks 4603 and block 4604 are repeated for another alert. In block 4606, each set of core alerts is identified as a cluster of alerts. In block 4607, each border alert is assigned to the cluster of alerts in which the border alert is density reachable from any alert in the cluster of alerts. In block 4608, identifying each alert with only one alert in the neighborhood as noise.

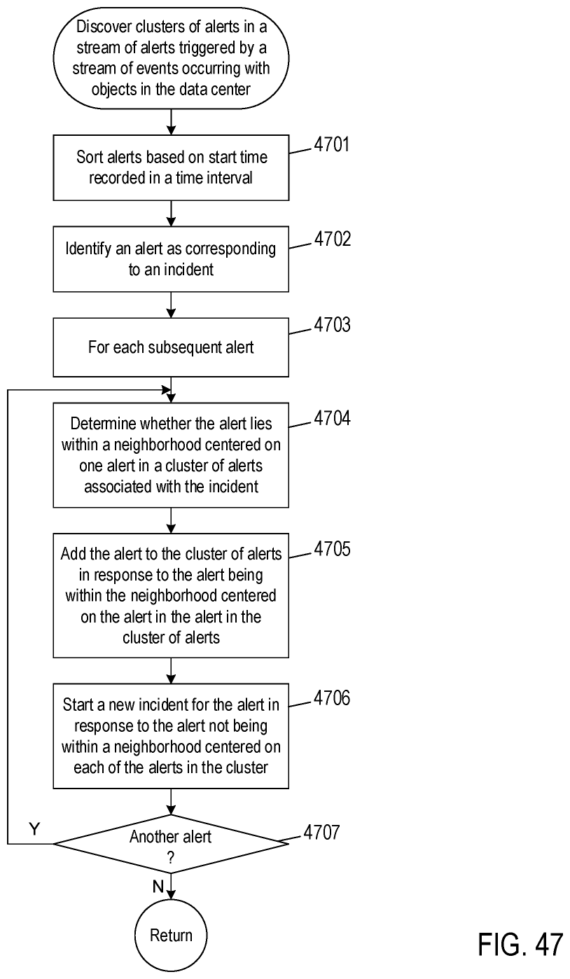

FIG. 47 is a flow diagram of the “discover clusters of alerts in a stream of alerts triggered by a stream of events occurring with objects in the data center” procedure performed in block 4501 of FIG. 45. In block 4701, alerts are sorted based on start time recorded in a time interval. In block 4702, an alert is identified as corresponding to an incident. A loop beginning with block 4703, repeats the operations represented by blocks 4704-4706 for each subsequent alert. In block 4704, determining whether the alert lies within a neighborhood centered on one alert in a cluster of alerts associated with the incident. In block 4704, the alert is added to the cluster of alerts in response to the alert being within the neighborhood centered on the alert in the alert in the cluster of alerts. In block 4705, a new incident is started for the alert in response to the alert not being within a neighborhood centered on each of the alerts in the cluster. In decision block 4707, the operations represented by blocks 4704 and 4705 are repeated for another alert.

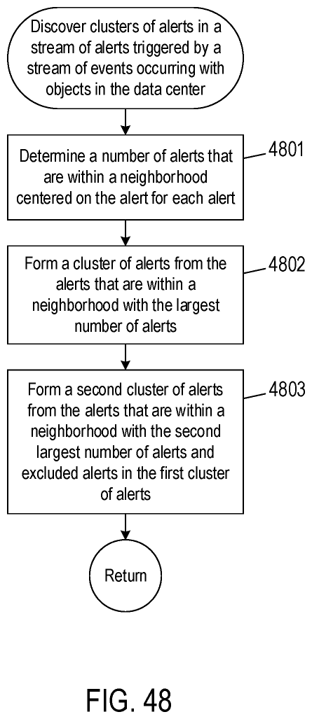

FIG. 48 is a flow diagram the “discover clusters of alerts in a stream of alerts triggered by a stream of events occurring with objects in the data center” procedure performed in block 4501 of FIG. 45. In block 4801, the number of alerts that are within a neighborhood centered on the alert are determined for each alert. In block 4802, a cluster of alerts is formed from the alerts that are within a neighborhood with the largest number of alerts. In block 4803, a second cluster of alerts is formed from the alerts that are within a neighborhood with the second largest number of alerts, aexclusing alerts in the first cluster of alerts.

FIG. 49 is a flow diagram of the “identify incidents in each cluster of alerts and store each incident in an incidents database” procedure performed in block 4502 of FIG. 45. In block 4901, the user feedback designates each runtime alert and a preceding alert that lies within a neighborhood of the runtime alert as not indicative, indicative, or a root cause based on an event type of the runtime alert and an event type of the preceding alert as described above with reference to FIGS. 35A-37B. In block 4902, the alert is assigned to an incident with related event types. In block 4903, the event types of the runtime alert and the preceding alert are recorded as a pair of event types in a not indicative event types database as described above with reference to FIG. 38. In block 4904, the pairs of event types in the not indicative event types database are used to designate each runtime alert and preceding alert as not indicative when an event type of the runtime alert and an event type of the preceding alert match a pair of event types in the not indicative event types database.

FIG. 50 is a flow diagram of the “identify incidents in each cluster of alerts and store each incident in an incidents database” procedure performed in block 4502 of FIG. 45. In block 5001, for each user of multiple users of the GUI, the feedback is used to designate each runtime alert and a preceding alert that lies within a neighborhood of the runtime alert as not indicative, indicative, or a root cause based on an event type of the runtime alert and an event type of the preceding alert. In block 5002, for each pair of even types designated by the multiple users as not indicative, a confidence score is computed based on levels of expertise of the users and fraction of users at each level of expertise that designated the event type of the runtime alert and the event type of the preceding alert as not indicative. In block 5003, the confidence scores of pairs of event types are used to designate a runtime alert and preceding alert as not indicative when an event type of the runtime alert and an event type of the preceding alert match a pair of event types in the not indicative event types database and the corresponding confidence score of the pair of events types is greater than a confidence score threshold.

FIG. 51 is a flow diagram of the “compare a set of runtime alerts to each incident stored in the incidents database to determine one or more incidents that are similar to the set of runtime alert” procedure performed in block 4503 of FIG. 45. A loop beginning with block 5101 repeats the operations described below for each incident stored in the incidents database. In block 5102, a similarity score is computed between the set of runtime alerts and the incident. In block 5103, the incidents are identified as similar to the set of incidents when the similarity score is greater than a similarity threshold.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A computer-implemented operations management server that discovers incidents occurring with objects running in a data center and executes remedial measures that correct the incidents, the operations management server performs operations comprising:
displaying a graphical user interface (“GUI”) on a display screen, the GUI enables a user to launch a process that discovers clusters of alerts in a stream of alerts triggered by a stream of events occurring with objects in the data center;
in response to the user launching the process, the GUI enables a user to input user feedback that identifies alerts with related event types in each cluster of alerts, the runtime alerts with related event types correspond to separate incidents occurring with objects in the data center, and store each incident in an incidents database;
in response to the user identifying alerts in each cluster of alerts that correspond to separate incidents, comparing a set of runtime alerts to each incident stored in the incidents database to determine one or more incidents that are similar to the set of runtime alerts;
displaying the one or more similar incidents and corresponding remedial measures in the GUI, each remedial measure being selectable to launch an operation that corrects one of the problems represented by the one or more similar incidents; and
in response to the user selecting one of the remedial measures via the GUI, executing the remedial measures to correct events of the objects that triggered the set of runtime alerts.

2. The operational manager of claim 1 wherein the process that discovers clusters of alerts in the stream of alerts triggered by the stream of events occurring with objects in the data center comprises:
retrieving alerts with start times in a runtime window from an alerts database, each alert corresponding to an event occurring with an object executing in the data center;
for each alert within a neighborhood centered on the alert,
identifying the alert as a core alert when the number of alerts that lie within the neighborhood are greater than a minimum points threshold, and
identifying the alert as a border alert when the number of alerts that lie within the neighborhood are less than the minimum points threshold and greater than one;
identifying each set of core alerts as a cluster of alerts;
assigning each border alert to the cluster of alerts in which the border alert is density reachable from any alert in the cluster of alerts; and
identifying each alert with only one alert in the neighborhood as noise.

3. The method of claim 1 wherein the process that discovers clusters of alerts in the stream of alerts triggered by the stream of events occurring with objects in the data center comprises:
sorting alerts based on start time recorded in a time interval;
identifying an alert as corresponding to an incident; and
for each subsequent alert,
determining whether the alert lies within a neighborhood centered on one alert in a cluster of alerts associated with the incident,
adding the alert to the cluster of alerts in response to the alert being within the neighborhood centered on the alert in the alert in the cluster of alerts, and
starting a new incident for the alert in response to the alert not being within a neighborhood centered on each of the alerts in the cluster.

4. The method of claim 1 wherein the process that discovers clusters of alerts in the stream of alerts triggered by the stream of events occurring with objects in the data center comprises:
for each alert, determining a number of alerts that are within a neighborhood centered on the alert;
forming a cluster of alerts from the alerts that are within a neighborhood with the largest number of alerts; and
forming a second cluster of alerts from the alerts that are within a neighborhood with the second largest number of alerts and excluded alerts in the first cluster of alerts.

5. The method of claim 1 wherein the GUI enables the user to input user feedback that identifies alerts with related event types in each cluster of alerts comprises:
using the feedback to designate each runtime alert and a preceding alert that lies within a neighborhood of the runtime alert as not indicative, indicative, or a root cause based on an event type of the runtime alert and an event type of the preceding alert;
in response to the user designating the runtime alert as indicate or a root cause, assigning the alert to an incident with related event types;
in response to the user designating the runtime alert and the preceding alert as not indicative, recording the event types of the runtime alert and the preceding alert as a pair of event types in a not indicative event types database; and
using pairs of event types in the not indicative event types database to designate a runtime alert and preceding alert as not indicative when an event type of the runtime alert and an event type of the preceding alert match a pair of event types in the not indicative event types database.

6. The method of claim 1 wherein the GUI enables the user to input user feedback that identifies alerts with related event types in each cluster of alerts comprises:
for each user of multiple users of the GUI, using the feedback to designate each runtime alert and a preceding alert that lies within a neighborhood of the runtime alert as not indicative, indicative, or a root cause based on an event type of the runtime alert and an event type of the preceding alert;
for each pair of even types designated by the multiple users as not indicative, computing a confidence score based on levels of expertise of the users and fraction of users at each level of expertise that designated the event type of the runtime alert and the event type of the preceding alert as not indicative; and
using the confidence scores of pairs of event types to designate a runtime alert and preceding alert as not indicative when an event type of the runtime alert and an event type of the preceding alert match a pair of event types in the not indicative event types database and the corresponding confidence score of the pair of events types is greater than a confidence score threshold.

7. The method of claim 1 wherein comparing alerts of a runtime incident to alerts of each incident stored in the incidents database to determine one or more incidents that are similar to the runtime incident comprises:
for each incident stored in the incidents database,
computing a similarity score between the runtime incident and the incident, and
identifying the incidents as similar to the runtime incident when the similarity score is greater than a similarity threshold.

8. A computer system for discovering incidents occurring with objects running in a data center and executing remedial measures that correct the incidents, the computer system comprising:
a display screen;
one or more processors;
one or more data-storage devices; and
machine-readable instructions stored in the one or more data-storage devices that when executed using the one or more processors control the system to perform operations comprising:
executing a process that discovers clusters of alerts in a stream of alerts triggered by a stream of events occurring with objects in the data center via a graphical user interface (“GUI”) displayed on the display screen;
using the GUI to receive user feedback that identifies alerts with related event types in each cluster of alerts, each set of alerts with related event types corresponding to a separate incident occurring with objects in the data center, and store each incident in an incidents database;
comparing a set of runtime alerts to each incident stored in the incidents database to determine one or more incidents that are similar to the set of runtime alerts;
displaying the one or more similar incidents and corresponding remedial measures in the GUI, each remedial measure being selectable to launch an operation that corrects one of the problems represented by the one or more similar incidents; and
in response to the user selecting one of the remedial measures via the GUI, executing the remedial measures to correct a problem with the one or more objects that triggered the set of runtime alerts.

9. The computer system of claim 8 wherein executing the process that discovers clusters of alerts in the stream of alerts triggered by the stream of events occurring with objects in the data center comprises:
getting alerts with start times in a runtime window from an alerts database, each alert corresponding to an event occurring with an object executing in the data center;
for each alert within a neighborhood centered on the alert,
identifying the alert as a core alert when the number of alerts that lie within the neighborhood are greater than a minimum points threshold, and
identifying the alert as a border alert when the number of alerts that lie within the neighborhood are less than the minimum points threshold and greater than one;
identifying each set of core alerts as a cluster of alerts;
assigning each border alert to the cluster of alerts in which the border alert is density reachable from any alert in the cluster of alerts; and
identifying each alert with only one alert in the neighborhood as noise.

10. The computer system of claim 8 wherein the process that discovers clusters of alerts in the stream of alerts triggered by the stream of events occurring with objects in the data center comprises:
sorting alerts based on start time recorded in a time interval;
identifying an alert as corresponding to an incident; and
for each subsequent alert,
determining whether the alert lies within a neighborhood centered on one alert in a cluster of alerts associated with the incident,
adding the alert to the cluster of alerts in response to the alert being within the neighborhood centered on the alert in the alert in the cluster of alerts, and
starting a new incident for the alert in response to the alert not being within a neighborhood centered on each of the alerts in the cluster.

11. The computer system of claim 8 wherein the process that discovers clusters of alerts in the stream of alerts triggered by the stream of events occurring with objects in the data center comprises:
for each alert, determining a number of alerts that are within a neighborhood centered on the alert;
forming a cluster of alerts from the alerts that are within a neighborhood with the largest number of alerts; and
forming a second cluster of alerts from the alerts that are within a neighborhood with the second largest number of alerts and excluded alerts in the first cluster of alerts.

12. The computer system of claim 8 wherein using the GUI to receive user feedback that identifies alerts with related event types in each cluster of alerts comprises:
using the feedback to designate each runtime alert and a preceding alert that lies within a neighborhood of the runtime alert as not indicative, indicative, or a root cause based on an event type of the runtime alert and an event type of the preceding alert;
in response to the user designating the runtime alert as indicate or a root cause, assigning the alert to an incident with related event types;
in response to the user designating the runtime alert and the preceding alert as not indicative, recording the event types of the runtime alert and the preceding alert as a pair of event types in a not indicative event types database; and
using pairs of event types in the not indicative event types database to designate a runtime alert and preceding alert as not indicative when an event type of the runtime alert and an event type of the preceding alert match a pair of event types in the not indicative event types database.

13. The computer system of claim 8 wherein using the GUI to receive user feedback that identifies alerts with related event types in each cluster of alerts comprises:
for each user of multiple users of the GUI, using the feedback to designate each runtime alert and a preceding alert that lies within a neighborhood of the runtime alert as not indicative, indicative, or a root cause based on an event type of the runtime alert and an event type of the preceding alert;
for each pair of even types designated by the multiple users as not indicative, computing a confidence score based on levels of expertise of the users and fraction of users at each level of expertise that designated the event type of the runtime alert and the event type of the preceding alert as not indicative; and
using the confidence scores of pairs of event types to designate a runtime alert and preceding alert as not indicative when an event type of the runtime alert and an event type of the preceding alert match a pair of event types in the not indicative event types database and the corresponding confidence score of the pair of events types is greater than a confidence score threshold.

14. The computer system of claim 1 wherein comparing alerts of the runtime incident to alerts of each incident stored in the incidents database to determine one or more incidents that are similar to the runtime incident comprises:
for each incident stored in the incidents database,
computing a similarity score between the runtime incident and the incident, and
identifying the incidents as similar to the runtime incident when the similarity score is greater than a similarity threshold.

15. A non-transitory computer-readable medium having instructions encoded thereon for enabling one or more processors of a computer system to perform operations comprising:
displaying a graphical user interface (“GUI”) on a display screen, the GUI enabling a user to launch a process that discovers clusters of alerts in a stream of alerts triggered by a stream of events occurring with objects in the data center;
in response to the user launching the process, the GUI enables a user to input user feedback that identifies alerts with related event types in each cluster of alerts, the runtime alerts with related event types correspond to separate incidents occurring with objects in the data center and store each incident in an incidents database;
in response to the user identifying alerts in each cluster of alerts that correspond to separate incidents, comparing a set of runtime alerts to each incident stored in the incidents database to determine one or more incidents that are similar to the set of runtime alerts;
displaying the one or more similar incidents and corresponding remedial measures in the GUI, each remedial measure being selectable to launch an operation that corrects one of the problems represented by the one or more similar incidents; and
in response to the user selecting one of the remedial measures via the GUI, executing the remedial measures to correct a problem with the one or more objects that triggered the set of runtime alerts.

16. The medium of claim 15 wherein the process that discovers clusters of alerts in the stream of alerts triggered by the stream of events occurring with objects in the data center comprises:
getting alerts with start times in a runtime window from an alerts database, each alert corresponding to an event occurring with an object executing in the data center;
for each alert within a neighborhood centered on the alert,
identifying the alert as a core alert when the number of alerts that lie within the neighborhood are greater than a minimum points threshold, and
identifying the alert as a border alert when the number of alerts that lie within the neighborhood are less than the minimum points threshold and greater than one;
identifying each set of core alerts as a cluster of alerts;
assigning each border alert to the cluster of alerts in which the border alert is density reachable from any alert in the cluster of alerts; and
identifying each alert with only one alert in the neighborhood as noise.

17. The medium of claim 15 wherein the process that discovers clusters of alerts in the stream of alerts triggered by the stream of events occurring with objects in the data center comprises:
sorting alerts based on start time recorded in a time interval;
identifying an alert as corresponding to an incident; and
for each subsequent alert,
determining whether the alert lies within a neighborhood centered on one alert in a cluster of alerts associated with the incident,
adding the alert to the cluster of alerts in response to the alert being within the neighborhood centered on the alert in the alert in the cluster of alerts, and
starting a new incident for the alert in response to the alert not being within a neighborhood centered on each of the alerts in the cluster.

18. The medium of claim 15 wherein the process that discovers clusters of alerts in the stream of alerts triggered by the stream of events occurring with objects in the data center comprises:
for each alert, determining a number of alerts that are within a neighborhood centered on the alert;
forming a cluster of alerts from the alerts that are within a neighborhood with the largest number of alerts; and
forming a second cluster of alerts from the alerts that are within a neighborhood with the second largest number of alerts and excluded alerts in the first cluster of alerts.

19. The medium of claim 15 wherein the GUI enables the user to input user feedback that identifies alerts with related event types in each cluster of alerts comprises:
using the feedback to designate each runtime alert and a preceding alert that lies within a neighborhood of the runtime alert as not indicative, indicative, or a root cause based on an event type of the runtime alert and an event type of the preceding alert;
in response to the user designating the runtime alert as indicate or a root cause, assigning the alert to an incident with related event types;
in response to the user designating the runtime alert and the preceding alert as not indicative, recording the event types of the runtime alert and the preceding alert as a pair of event types in a not indicative event types database; and
using pairs of event types in the not indicative event types database to designate a runtime alert and preceding alert as not indicative when an event type of the runtime alert and an event type of the preceding alert match a pair of event types in the not indicative event types database.

20. The medium of claim 15 wherein the GUI enables the user to input user feedback that identifies alerts with related event types in each cluster of alerts comprises:
for each user of multiple users of the GUI, using the feedback to designate each runtime alert and a preceding alert that lies within a neighborhood of the runtime alert as not indicative, indicative, or a root cause based on an event type of the runtime alert and an event type of the preceding alert;
for each pair of even types designated by the multiple users as not indicative, computing a confidence score based on levels of expertise of the users and fraction of users at each level of expertise that designated the event type of the runtime alert and the event type of the preceding alert as not indicative; and
using the confidence scores of pairs of event types to designate a runtime alert and preceding alert as not indicative when an event type of the runtime alert and an event type of the preceding alert match a pair of event types in the not indicative event types database and the corresponding confidence score of the pair of events types is greater than a confidence score threshold.

21. The medium of claim 15 wherein comparing alerts of a runtime incident to alerts of each incident stored in the incidents database to determine one or more incidents that are similar to the runtime incident comprises:
for each incident stored in the incidents database,
computing a similarity score between the runtime incident and the incident, and
identifying the incidents as similar to the runtime incident when the similarity score is greater than a similarity threshold.
